(19) United States
(12) Patent Application Publication
(10) Pub. No.: US 2019/0259014 A1
(43) Pub. Date: Aug. 22, 2019

(54) AGE VERIFICATION SYSTEM AND SHOPPING ASSISTANCE SYSTEM COMPRISING SAME

(71) Applicant: Panasonic Intellectual Property Management Co., Ltd., Osaka (JP)

(72) Inventors: TSUYOSHI KATAYAMA, Kyoto (JP); AKIHITO SAKANAKA, Osaka (JP); KEI KOBAYASHI, Osaka (JP); MIWA ISHITSUBO, Kyoto (JP); SHINSUKE OGATA, Tokyo (JP)

(21) Appl. No.: 16/344,383

(22) PCT Filed: Oct. 3, 2017
(86) PCT No.: PCT/JP2017/035900

§ 371 Date: Apr. 24, 2019

(30) Foreign Application Priority Data
Nov. 8, 2016 (JP) 2016-218251
Mar. 31, 2017 (JP) 2017-072706

(51) Int. Cl. G06Q 20/20; G06Q 20/12; G06K 9/00; G06F 3/14

(52) U.S. Cl. CPC G06Q 20/206; G06Q 20/12; G06K 2009/00322; G06F 3/14; G06K 9/00228

(57) ABSTRACT

An age verification system includes a management apparatus and a mobile terminal. The management apparatus transmits a request signal including image data. The mobile terminal includes a communication unit, a display unit, an operation unit, and a response processing unit. The communication unit receives the request signal from the management apparatus. The display unit displays an age verification screen by using the image data included in the request signal. The operation unit receives an operation input by a confirmer when the age verification screen is viewed by the confirmer, as an age verification result. The response processing unit transmits a response signal including the age verification result to the management apparatus.

### TECHNICAL FIELD

The present disclosure relates generally to an age verification system and a shopping assistance system including the same, and more particularly to an age verification system used for age verification of a target person and a shopping assistance system including the same.

### BACKGROUND ART

In PTL 1, a system (POS system) aimed at unmanned stores without salespersons is disclosed.

The system disclosed in PTL 1 is configured with a basket for putting products and a transaction terminal device. The basket includes a scanner that reads product information (product data), and a transmission circuit that transmits the product information to the outside. The transaction terminal device includes a receiving circuit that receives the product information, a measurement device that measures a weight of products put in the basket, and a control unit that compares weight data corresponding to the product information with a measured value of the measurement device. The transaction terminal device performs settlement processing in a case where the measured value of the measurement device matches with the total weight of the weight data.

### CITATION LIST

### Patent Literature

PTL 1: Japanese Patent Unexamined Publication No. 5-89364

### SUMMARY OF THE INVENTION

An age verification system includes a management apparatus and a mobile terminal.

The management apparatus includes a request processing unit that transmits a request signal including image data of an image obtained by capturing a target person.

The mobile terminal includes a communication unit, a display unit, an operation unit, and a response processing unit.

The communication unit receives the request signal from the management apparatus.

The display unit displays an age verification screen including the image by using the image data included in the request signal.

The operation unit receives an operation input by a confirmer when the age verification screen is viewed by the confirmer, as an age verification result.

The response processing unit transmits a response signal including the age verification result received by the operation unit to the management apparatus.

A shopping assistance system includes the age verification system and a sales system.

The sales system can perform communication with the management apparatus, and performs sales processing of a product.

In a case where a specific product requiring age verification of the target person at the time of sale is sold in the sales system, the management apparatus transmits the request signal to the mobile terminal, and transmits a permission signal to the sales system when receiving the response signal indicating pass of the age verification from the mobile terminal.

### BRIEF DESCRIPTION OF DRAWINGS

FIG. 1 is a system configuration diagram illustrating a schematic configuration of a shopping assistance system according to an embodiment.

FIG. 2 is a block diagram of the shopping assistance system according to the embodiment.

FIG. 3 is an external perspective view of a counter table to which the shopping assistance system according to the embodiment is applied.

FIG. 4 is a sequence diagram illustrating an operation of the shopping assistance system according to the embodiment.

FIG. 5 is a conceptual diagram illustrating an operation of an age verification system according to the embodiment.

FIG. 6 is an explanatory diagram illustrating an example of an age verification screen of a mobile terminal of the age verification system according to the embodiment.

FIG. 7 is a flowchart illustrating an operation of the mobile terminal according to the embodiment.

FIG. 8A is an external view of the mobile terminal of the age verification system according to a first modification example of the embodiment.

FIG. 8B is an enlarged view of a main part of FIG. 8A.

FIG. 9 is a block diagram of the mobile terminal of the age verification system according to the embodiment.

FIG. 10A is a perspective view of the mobile terminal of the age verification system according to the embodiment in a state where a display unit faces forward.

FIG. 10B is a perspective view of the mobile terminal of the age verification system according to the embodiment in a state where the display unit faces upward.

FIG. 11 is an external view of the mobile terminal of the age verification system according to a second modification example of the embodiment.

### DESCRIPTION OF EMBODIMENTS

In a case where it is attempted to realize an unmanned shopping system using the system described in PTL 1, there is a problem in sale of a specific product such as a liquor or a cigarette requiring age verification at the time of sale.

(1) Outline

An age verification system according to the present embodiment is a system that assists verification of an age of a target person by a confirmer. Here, “age verification” means that a confirmer (a seller or the like) confirms whether or not an age of a target person (a purchaser or the like) is equal to or higher than a specific age in a case of selling a product such as a cigarette or a liquor, of which the sale is restricted to a person under the specified age according to laws and regulations. In other words, in age verification, it is confirmed whether or not a condition is satisfied, the condition for determining that the age of the target person is equal to or higher than the specific age. A result of the age verification is “pass” when the condition is satisfied (the age of the target person is equal to or higher than the specific age), and is “fail” when the condition is not satisfied (the age of the target person is lower than the specific age).

In the present embodiment, as an example, a case where the age verification system is applied to a retail store such as a convenience store, a supermarket, a department store, a drug store, a home electric appliances retail store, or a home center and is used for age verification of a customer by a salesperson, will be described. In this case, a salesperson (seller) is a confirmer, and a customer (purchaser) is a target person of the age verification.

In such stores, for example, in a case where a self-checkout is provided at a checkout counter, when a customer purchases a product, there is a case where there is no salesperson near the customer (that is, near the checkout counter). Under such a circumstance, in order to allow the customer to purchase a specific product requiring age verification, a salesperson needs to move to the checkout counter for age verification, and the customer needs to wait for arrival of the salesperson. As a result, much labor is required for age verification. In such a self-checkout system that allows a customer to purchase a product without requiring an operation of a salesperson, originally, it is expected to reduce labor of a salesperson and to reduce labor of a customer waiting in line at a checkout counter. For this reason, a fact that much labor of persons (a salesperson and a customer) is required for age verification is not particularly preferable. An age verification system according to the present embodiment can realize age verification while reducing labor of persons (a salesperson and a customer) by adopting the following configuration allowing efficient age verification even under such a circumstance.

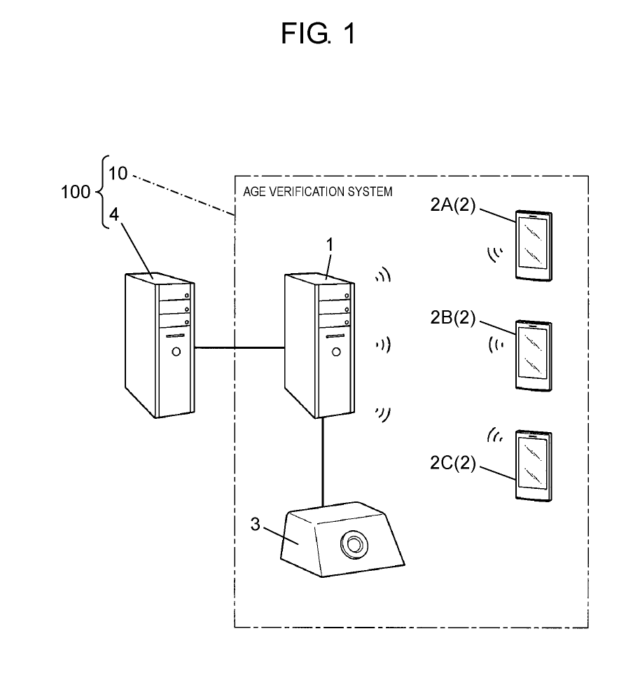

FIG. 1 is a system configuration diagram illustrating a schematic configuration of shopping assistance system 100 according to an embodiment. As illustrated in FIG. 1, age verification system 10 according to the present embodiment includes management apparatus 1 and at least one mobile terminal 2A, 2B, or 2C (in the example of FIG. 1, three mobile terminals). Hereinafter, each of a plurality of mobile terminals 2A, 2B, and 2C may be referred to as “mobile terminal 2” in a case where the plurality of mobile terminals 2A, 2B, and 2C are not specifically distinguished.

Mobile terminal 2 can perform bidirectional communication with management apparatus 1. Management apparatus 1 transmits a request signal including image data of an image obtained by capturing a target person (in the present embodiment, a customer) as a target of age verification, to mobile terminal 2. Mobile terminal 2 displays an age verification screen including the image obtained by capturing the target person, by using the image data included in the received request signal. In this state, a confirmer (in the present embodiment, a salesperson) different from the target person confirms an age of the target person by viewing the age verification screen displayed on mobile terminal 2. When a result of the age verification performed by the confirmer in this manner is input as an operation of the confirmer, mobile terminal 2 transmits a response signal including the result of the age verification to management apparatus 1.

In short, in age verification system 10 according to the present embodiment, the image data of the image obtained by capturing the target person is transmitted from management apparatus 1 to mobile terminal 2, and thus the confirmer can confirm the age of the target person by viewing the image of the target person on the age verification screen displayed on mobile terminal 2. Further, since the result of the age verification performed on mobile terminal 2 is returned from mobile terminal 2 to management apparatus 1 as a transmission source of the request signal, and a series of processing for the age verification is started on management apparatus 1 and is completed on management apparatus 1. Therefore, in a case where the confirmer carries mobile terminal 2, even when the confirmer is at a place away from the target person, the confirmer can confirm the age of the target person without leaving the place, that is, without moving from the place. In addition, for age verification, the target person does not need to wait for arrival of a confirmer who is at a place away from the target person. Thereby, according to age verification system 10, it is possible to realize age verification while reducing labor of persons (a salesperson and a customer).

Age verification system 10 according to the present embodiment constitutes shopping assistance system 100 (refer to FIG. 1) for assisting shopping of customers at a store such as a retail store, together with sales system 4 (refer to FIG. 1). In other words, shopping assistance system 100 includes age verification system 10 and sales system 4.

Sales system 4 can perform communication with management apparatus 1, and is a system for performing sales processing of products. Here, “sales processing” means various processing required for an act (selling) in which ownership of a product is transferred from a seller (a store) to a buyer (a customer) and the buyer pays a price (a payment) corresponding to the product to the seller. For example, the sales processing includes acquisition processing of acquiring product information of a product picked up by a customer in a store, order processing of inputting designation of a product desired to be purchased from a customer, and the like.

In shopping assistance system 100, sales system 4 and age verification system 10 cooperate with each other, and thus the following functions are realized.

That is, management apparatus 1 is configured to transmit a request signal to mobile terminal 2 in a case where a specific product requiring age verification of a target person (in the present embodiment, a customer) at the time of sale is sold on sales system 4. In addition, management apparatus 1 is configured to transmit a permission signal to sales system 4 when receiving a response signal indicating pass of age verification from mobile terminal 2.

In short, in shopping assistance system 100 according to the present embodiment, in response to a fact that the specific product is sold on sales system 4, management apparatus 1 transmits a request signal to mobile terminal 2, and age verification system 10 starts a series of processing for age verification. In addition, when a result of the age verification is pass, a permission signal is transmitted from management apparatus 1 to sales system 4, and thus sales system 4 can receive the result of the age verification performed on age verification system 10. For example, in a case where a customer intends to purchase a specific product such as a cigarette or a liquor using sales system 4, age verification is performed on age verification system 10, and a result of the age verification is transmitted to sales system 4. Therefore, shopping assistance system 100 according to the present embodiment can allow sale of a specific product such as a liquor or a cigarette requiring age verification at the time of sale, for example, while realizing automation (unmanned processing) of at least a part of the sales processing on sales system 4. As a result, according to shopping assistance system 100, it is possible to reduce labor of a customer and a salesperson who is involved in shopping of the customer.

In addition, as described above, since age verification system 10 cooperates with sales system 4, only when a specific product is sold, that is, only when age verification is required, age verification system 10 is allowed to perform age verification. Therefore, compared with a case where age verification is performed for customers who do not purchase a specific product, an operating time of age verification system 10 can be shortened, and labor of a confirmer (in the present embodiment, a salesperson) can be reduced.

(2) Details

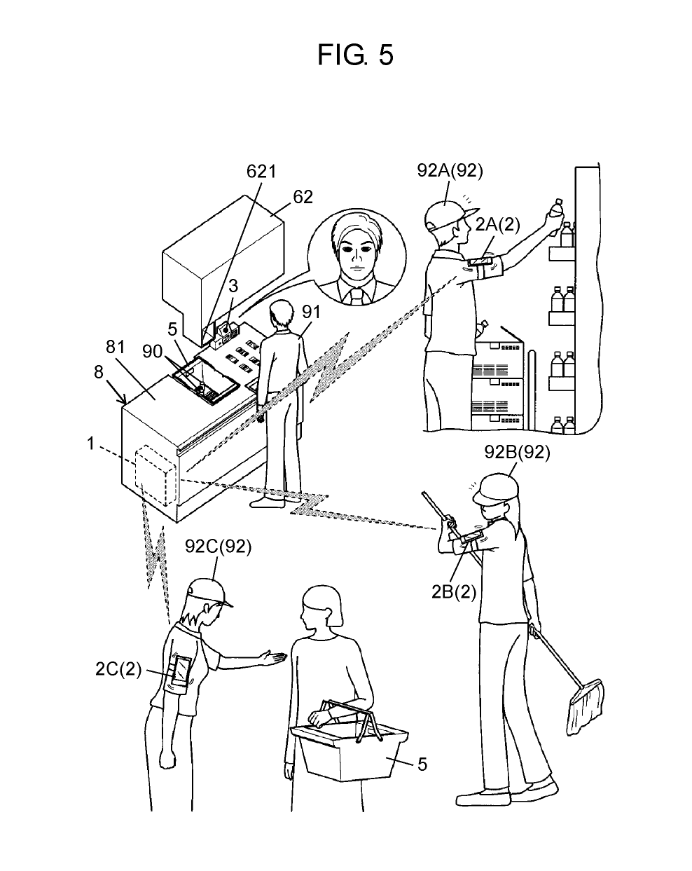

Hereinafter, age verification system 10 according to the present embodiment and shopping assistance system 100 including age verification system 10 will be described in detail. In the present embodiment, a convenience store will be described as an example of a store to which age verification system 10 and shopping assistance system 100 are applied. That is, a target person as a target of age verification is customer 91 (refer to FIG. 5) of the convenience store, and confirmers are salespersons 92A, 92B, and 92C (refer to FIG. 5) of the convenience store. Hereinafter, each of a plurality of salespersons 92A, 92B, and 92C may be referred to as “salesperson 92” in a case where the plurality of salespersons 92A, 92B, and 92C are not specifically distinguished.

(2.1) Overall Configuration

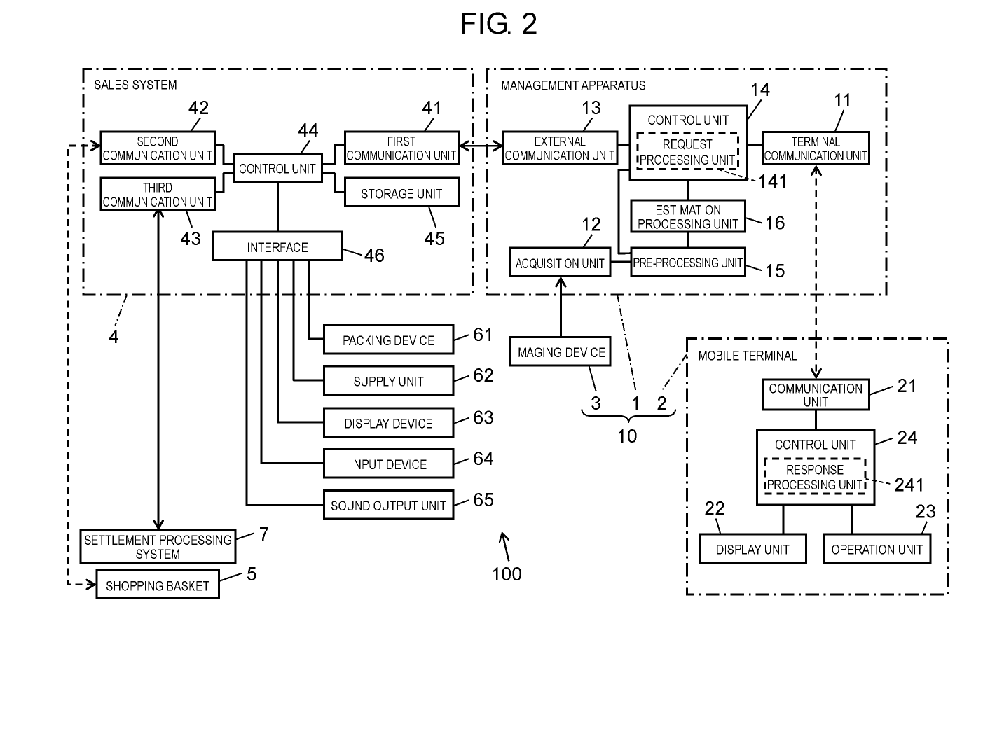

First, an overall configuration of shopping assistance system 100 according to the present embodiment will be described. FIG. 2 is a block diagram of shopping assistance system 100 according to the present embodiment. As illustrated in FIG. 2, shopping assistance system 100 further includes imaging device 3, shopping basket 5, packing device 61, supply unit 62, display device 63, input device 64, and sound output unit 65, in addition to management apparatus 1, mobile terminal 2, and sales system 4. Here, age verification system 10 includes the plurality of mobile terminals 2A, 2B, and 2C (refer to FIG. 1). On the other hand, since the plurality of mobile terminals 2A, 2B, and 2C have a common configuration, in FIG. 2, only one mobile terminal 2 is illustrated and other mobile terminals 2 are not illustrated.

Imaging device 3 is a camera that captures an image of customer 91. In the present embodiment, it is assumed that imaging device 3 is included in age verification system 10 as a component. In other words, age verification system 10 includes management apparatus 1, mobile terminal 2, and imaging device 3. That is, management apparatus 1 is configured to acquire image data of the image obtained by capturing customer 91 by imaging device 3, from imaging device 3, as image data to be used for age verification of customer 91 (target person).

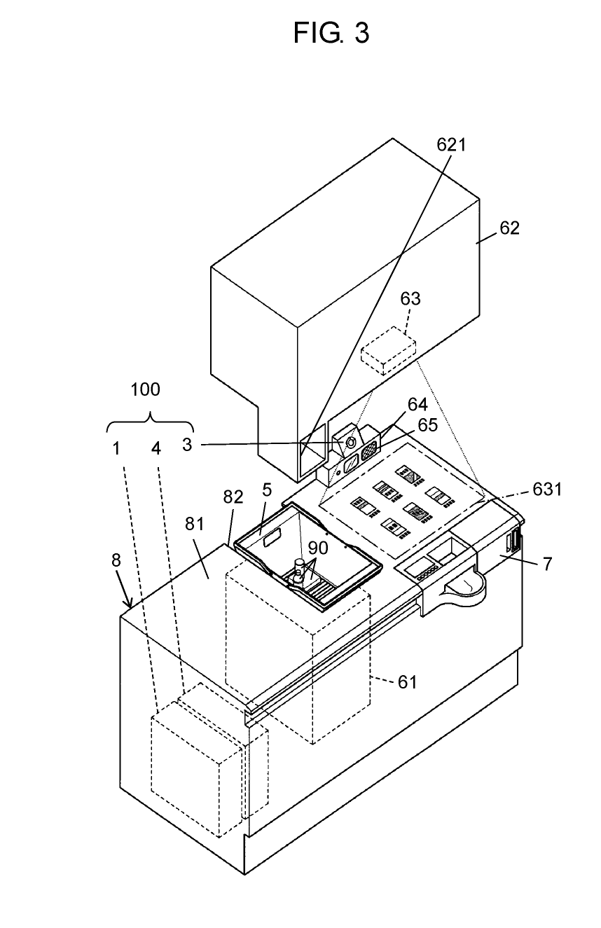

In shopping basket 5, a battery and a circuit block including various circuits and modules which operate under power supply from the battery are included. Here, a part of the circuit block, such as operation buttons and a display, is exposed from a front surface of shopping basket 5. Shopping basket 5 is configured to allow product 90 to be put therein (refer to FIG. 3), and also has a function of communicating with sales system 4 and a function of reading product information of product 90. Here, “product information” is information for identifying product 90 (product identification code), and, for example, is a Japanese article number (JAN) code used in Japan. Shopping basket 5 reads the product information using, for example, a barcode reader, an image sensor, or the like. Thus, shopping basket 5 is able to read the product information from product 90 and transmit the product information to sales system 4 while product 90 picked up by customer 91 in the store is being put into shopping basket 5.

Sales system 4 receives the product information transmitted from shopping basket 5. Further, sales system 4 is configured to be able to communicate with settlement processing system 7 that performs settlement processing. Settlement processing system 7 is configured with, for example, a point of sales (POS) terminal. Settlement processing system 7 can perform settlement processing of product 90 based on the product information received from shopping basket 5 by sales system 4. In the present embodiment, although settlement processing system 7 is not included in shopping assistance system 100 as a component, settlement processing system 7 may be included in shopping assistance system 100 as a component.

In addition, sales system 4 is configured to be able to communicate with management apparatus 1 of age verification system 10. Age verification system 10 is a system that assists age verification of customer 91 (a target person) by salesperson 92 (a confirmer). In age verification system 10, bidirectional communication is performed between management apparatus 1 and mobile terminal 2, and thus salesperson 92 who carries mobile terminal 2 can perform age verification of customer 91 by viewing the image of customer 91 that is captured by imaging device 3. A result of the age verification (a response signal) is returned (transmitted) from mobile terminal 2 to management apparatus 1, and thus sales system 4 can receive the result of the age verification from management apparatus 1.

Age verification system 10 will be described in more detail in a section of “(2.2) Age Verification System”. Sales system 4 will be described in more detail in a section of “(2.3) Sales system”.

All of packing device 61, supply unit 62, display device 63, input device 64, and sound output unit 65 are peripheral devices of sales system 4, and are connected to sales system 4.

Packing device 61 is a device that performs packing of product 90 by transferring product 90 put in shopping basket 5 placed at a specified position from shopping basket 5 to a container. Here, “packing” includes not only packing product 90 to fill a container, but also putting (holding) product 90 into a certain container (holder) which can hold product 90. When a plurality of products 90 are put in shopping basket 5, packing device 61 also can collectively transfer the plurality of products 90 into the container. In the present embodiment, a case where the container is a polyethylene bag, that is, a so-called shopping bag (or a plastic bag) is taken as an example. Since the container is a bag, “packing” performed by packing device 61 means “bagging”. Here, packing device 61 may have any configuration as long as packing device 61 can put product 90 in the container. For example, packing device 61 may have a configuration of putting (packing) a product in a container such as an eco-bag, a take-out basket, or a box, as well as in a bag.

Supply unit 62 is a device that supplies a specific product (in the present embodiment, a cigarette) to a customer. Display device 63 is a device that performs various displaying for customer 91. Input device 64 is a device that receives an operation of customer 91 by, for example, gesture detection or the like. In addition, input device 64 includes a microphone, and has a function of performing voice recognition processing and semantic analysis processing of a voice signal input from the microphone. Thus, customer 91 can also perform a voice operation (voice input). Sound output unit 65 includes a speaker, and is a device that provides various types of information to customer 91 using a sound.

That is, by using display device 63, input device 64, and sound output unit 65 as a user interface, sales system 4 can provide various types of information to customer 91 by a display or a voice, or receive an operation of customer 91 (including voice input). Here, providing of information by sales system 4 may be realized by at least one of a display and a voice, may be realized by one of a display and a voice, or may be realized by a combination of a display and a voice.

As an example, sales system 4 can provide a message such as “welcome” or “thank you” to customer 91 when starting or ending settlement processing of a settlement amount (a payment amount). Therefore, it is possible to give customer 91 a feeling of friendliness close to a feeling when salesperson 92 welcomes the customer. In addition, customer 91 selects a payment method by, for example, operating input device 64, and performs settlement by paying the settlement amount displayed on display device 63. Further, sales system 4 can also provide an operation procedure of sales system 4 to the customer using display device 63 and sound output unit 65. In this case, preferably, display device 63 and sound output unit 65 provide an explanation of the operation procedure in order by using, for example, a message prompting the customer to place shopping basket 5 at a specific position and confirm the presence or absence of purchase of a cigarette.

FIG. 3 is an external perspective view of counter table 8 to which shopping assistance system 100 according to the embodiment is applied. Shopping assistance system 100 is provided, for example, in the vicinity of one counter table 8 provided at a checkout counter of a store, together with settlement processing system 7, excluding mobile terminal 2 and shopping basket 5. That is, in the vicinity of counter table 8, management apparatus 1, imaging device 3, sales system 4, settlement processing system 7, packing device 61, supply unit 62, display device 63, input device 64, and sound output unit 65 are provided.

In the example of FIG. 3, management apparatus 1, sales system 4, and packing device 61 are incorporated in counter table 8. Packing device 61 is disposed at a position corresponding to a substantially-central portion of counter table 8 when counter table 8 is viewed from the front. Settlement processing system 7 is disposed on the right side of packing device 61 when counter table 8 is viewed from the front. A plurality of counter tables 8 provided with management apparatus 1, sales system 4, packing device 61, and the like may be provided for one store.

Recess 82 as an opening is formed at a substantially-central portion of upper surface 81 of counter table 8 in a longitudinal direction (a lateral direction). Recess 82 forms a space for placing shopping basket 5. In the example of FIG. 3, shopping basket 5 is placed in recess 82. On the other hand, when customer 91 moves in a store, customer 91 holds shopping basket 5 with his or her hand or use shopping basket 5 being placed on a cart, and in this case, shopping basket 5 is not at a fixed position. Recess 82 is opened to face rearward when counter table 8 is viewed from the front. Packing device 61 is provided below recess 82.

Shopping basket 5 is configured such that, for example, a bottom plate thereof is slidable. Thereby, a bottom portion of shopping basket 5 can be opened and closed, and thus product 90 put in shopping basket 5 can be discharged from the bottom portion of shopping basket 5. Therefore, in a state where shopping basket 5 in which product 90 is put is placed at a specific position (on a bottom surface of recess 82 of counter table 8), when the bottom portion of shopping basket 5 is opened, product 90 in shopping basket 5 is discharged onto packing device 61. At this time, packing device 61 automatically performs packing processing of product 90 discharged from the bottom portion of shopping basket 5.

Supply unit 62 is suspended from a ceiling so as to be disposed above counter table 8.

Display device 63 is fixed to a lower surface of supply unit 62, and is configured to project an image on a screen by, for example, a projection mapping technique. Here, display device 63 projects an image on a right area of recess 82 on upper surface 81 of counter table 8 when counter table 8 is viewed from the front. That is, the right area of recess 82 on upper surface 81 of counter table 8 is served as screen 631 of display device 63. In the example of FIG. 3, a cigarette menu screen for selecting brands of cigarettes is displayed on screen 631. Here, the screen on which an image is projected by display device 63 is not limited to a flat surface (upper surface 81 of counter table 8), and may be an object having a three-dimensional shape. For example, when a mannequin which is patterned after an upper body of a person is served as a screen, display device 63 can make the mannequin look like various persons by a projection mapping technique.

Input device 64 is provided on upper surface 81 of counter table 8 and at the rear of screen 631 when counter table 8 is viewed from the front. Sound output unit 65 is integrally provided to input device 64. Imaging device 3 is provided above input device 64. A lens of imaging device 3 faces forward (customer 91 side) when counter table 8 is viewed from the front. Here, imaging device 3 is integrally provided with input device 64. Here, as long as imaging device 3 is provided at a position at which an image of a face of customer 91 can be captured, the position of imaging device 3 is merely an example, and for example, imaging device 3 may be fixed to the lower surface of supply unit 62.

Settlement processing system 7 includes a main computer system and peripheral devices such as a cash unit for receiving and discharging cash. Settlement processing system 7 performs settlement processing such as calculation of a settlement amount based on the product information received from sales system 4, by causing a processor of the computer system to execute a program recorded in a memory of the computer system. Settlement processing system 7 includes a card reader and a printer which issues a receipt. The card reader can read a card to be used for settlement such as a credit card, an electronic money card, a mobile phone, a membership card, or a point card. On the receipt, for example, information such as details, a settlement amount, a purchase date and time is printed.

Settlement processing system 7 is configured to be able to communicate with a store server provided in the store. The store server is configured to be able to communicate with a center server provided in a head office by which a plurality of stores are managed via a network such as the Internet. Settlement processing system 7 appropriately receives and transmits information on, for example, product 90 or customer 91, from and to the store server or the center server, by communicating with the store server or the center server.

In a store to which shopping assistance system 100 is applied, customer 91 can finish purchase of product 90 by a series of processing of picking-up product 90 in the store, putting product 90 in shopping basket 5, performing settlement, and then receiving automatically-packed product 90. Therefore, according to shopping assistance system 100, it is possible to shorten a time required for delivering of product 90 to customer 91, from, for example, the start of the settlement processing, while reducing labor of salesperson 92 and customer 91, and thus it is possible to shorten a time required for shopping of customer 91.

Further, in shopping assistance system 100 and settlement processing system 7, positional relationships, shapes, and the like of the units are merely an example, and may be appropriately changed. For example, supply unit 62 may be provided not above counter table 8 but on a side of counter table 8. Packing device 61 and recess 82 may be disposed at one end portion (a left end portion or a right end portion) of counter table 8 in the longitudinal direction (lateral direction). Further, it is not an essential configuration for shopping assistance system 100 that recess 82 is opened to face rearward when counter table 8 is viewed from the front. Originally, it is not an essential configuration for shopping assistance system 100 that recess 82 is formed on counter table 8. For example, a space for placing shopping basket 5 may be set on upper surface 81 of counter table 8.

(2.2) Age Verification System

Next, age verification system 10 will be described in more detail.

As illustrated in FIG. 2, age verification system 10 includes management apparatus 1, mobile terminal 2, and imaging device 3. In the following, first, management apparatus 1 will be described, and then mobile terminal 2 will be described.

Management apparatus 1 includes terminal communication unit 11, acquisition unit 12, external communication unit 13, control unit 14, pre-processing unit 15, and estimation processing unit 16.

Terminal communication unit 11 is a communication module that performs bidirectional communication with mobile terminal 2. Terminal communication unit 11 performs communication with mobile terminal 2 by wireless communication such as Wi-Fi (registered trademark) or Bluetooth (registered trademark) using a radio wave as a medium.

Acquisition unit 12 is connected to imaging device 3, and acquires image data of an image obtained by capturing customer 91 from imaging device 3. In the present embodiment, imaging device 3 constantly outputs a moving image to management apparatus 1. On the other hand, only when a request is received from management apparatus 1 (acquisition unit 12), imaging device 3 may output a moving image or a still image to management apparatus 1. Further, in the present embodiment, imaging device 3 is a color camera. On the other hand, imaging device 3 may be a monochromatic camera.

External communication unit 13 is a communication module that performs bidirectional communication with sales system 4. External communication unit 13 is connected to sales system 4 by, for example, a local area network (LAN) cable.

Control unit 14 includes a main computer system, and controls each unit of management apparatus 1, such as terminal communication unit 11, by causing a processor of the computer system to execute a program recorded in a memory of the computer system. The program may be recorded in advance in the memory, may be provided through an electric communication line such as the Internet, or may be provided by being recorded in a recording medium such as a memory card.

Control unit 14 acquires the image data of the image obtained by capturing customer 91 (a target person) as a target of age verification by imaging device 3, from acquisition unit 12. Further, control unit 14 has a function as request processing unit 141 that transmits a request signal for requesting salesperson 92 (confirmer) to perform age verification to mobile terminal 2 by terminal communication unit 11. Request processing unit 141 includes at least the image data of the image acquired by acquisition unit 12 into a request signal, and transmits the request signal to mobile terminal 2.

In the present embodiment, request processing unit 141 is configured to transmit a request signal including text data, and details will be described in a section of “(3.2) Age Verification Operation”. That is, the request signal transmitted from management apparatus 1 to mobile terminal 2 includes not only image data but also text data. Further, request processing unit 141 receives a response signal including a result of age verification performed by salesperson 92 from mobile terminal 2 by terminal communication unit 11.

In addition, control unit 14 receives a start signal from sales system 4 by external communication unit 13, and transmits a permission signal to sales system 4 by external communication unit 13. Here, “start signal” is a signal generated, for example, when a specific product is sold by sales system 4. Here, “permission signal” is, for example, a signal for permitting sales system 4 to sell a specific product. When receiving the start signal from sales system 4, control unit 14 starts a series of processing for age verification on age verification system 10, and details will be described in a section of “(3.2) Age Verification Operation”. When a result of the age verification included in the response signal is “pass”, that is, when the age verification on age verification system 10 is passed, control unit 14 transmits a permission signal to sales system 4.

Pre-processing unit 15 is connected to acquisition unit 12 and control unit 14, and executes face detection processing on the image data acquired by acquisition unit 12. That is, pre-processing unit 15 is configured to detect a face of customer 91 (target person) by performing image analysis of the image data acquired from imaging device 3, and transmit a request signal including the image data to request processing unit 141 (control unit 14). Thus, request processing unit 141 can limit image data to be included in the request signal, to the image data of the image including the face of customer 91.

Estimation processing unit 16 is connected to pre-processing unit 15 and control unit 14, and executes estimation processing of an age of customer 91 (target person) based on the image data acquired by acquisition unit 12. That is, estimation processing unit 16 estimates whether an age of customer 91 is equal to or higher than the specific age by performing image analysis of the image data acquired from imaging device 3. Here, “specific age” is a reference age for comparison with the age of the target person in the age verification on age verification system 10, and, for example, in Japan, a specific age for age verification related to cigarette sale is 20. In short, whether or not the age verification is passed is automatically determined by estimation processing unit 16. An estimation result of estimation processing unit 16 is output to request processing unit 141 (control unit 14). When receiving the estimation result of estimation processing unit 16, request processing unit 141 transmits a request signal including the estimation result to mobile terminal 2. Thus, request processing unit 141 can transmit a request signal including the estimation result of estimation processing unit 16 to mobile terminal 2, in addition to the image data. The estimation result of estimation processing unit 16 is not used for immediately determining pass/fail of the age verification of age verification system 10, and is used for assisting age verification to be performed on mobile terminal 2 by salesperson 92 (confirmer). Details will be described in a section of “(3.3) Estimation Processing”. That is, in a case where the estimation result of estimation processing unit 16 indicates that the age of customer 91 is equal to or higher than the specific age, when salesperson 92 accepts the estimation result, the age verification is passed, and when salesperson 92 rejects the estimation result, the age verification is failed.

In the present embodiment, between pre-processing unit 15 and control unit 14, there are a first path without passing through estimation processing unit 16 and a second path passing through estimation processing unit 16. The first path and the second path can be alternatively selected by control unit 14. That is, in a state where the first path is selected, the function of estimation processing unit 16 is disabled, and request processing unit 141 directly acquires the image data from pre-processing unit 15 without passing through estimation processing unit 16. In a state where the second path is selected, the function of estimation processing unit 16 is enabled, and request processing unit 141 indirectly acquires the image data from pre-processing unit 15 passing through estimation processing unit 16. In other words, in management apparatus 1, enabling/disabling of estimation processing unit 16 can be switched.

Mobile terminal 2 includes communication unit 21, display unit 22, operation unit 23, and control unit 24. In the present embodiment, as an example, mobile terminal 2 is a general-purpose smart phone. Mobile terminal 2 functions as communication unit 21, display unit 22, operation unit 23, and control unit 24 by installing dedicated application software and activating the application software. Mobile terminal 2 is constantly carried by salesperson 92.

Communication unit 21 is a communication module that performs bidirectional communication with management apparatus 1 (terminal communication unit 11). Communication unit 21 performs communication with management apparatus 1 by wireless communication such as Wi-Fi (registered trademark) or Bluetooth (registered trademark) using a radio wave as a medium. In the present embodiment, since mobile terminal 2 is a general-purpose smart phone, in a case where there is an incoming call, for example, in a case where a request signal is received from management apparatus 1, mobile terminal 2 performs incoming call notification for notifying salesperson 92 of the incoming call by using, for example, a ring tone, a light emitting function, or a vibration function.

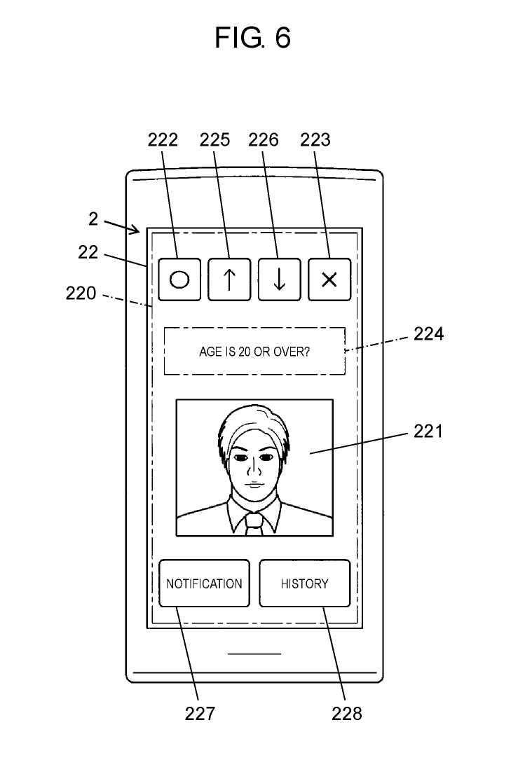

Display unit 22 displays data received by communication unit 21. Display unit 22 includes, for example, a liquid crystal display (LCD). Display unit 22 functions as a browser for displaying data distributed (transmitted) as contents from management apparatus 1 as a video. Display unit 22 displays at least age verification screen 220 (refer to FIG. 6) for allowing salesperson 92 to perform age verification of customer 91, and details will be described in a section of “(3.2) Age Verification Operation”. That is, when communication unit 21 receives the request signal from management apparatus 1, display unit 22 displays age verification screen 220 including the image obtained by capturing customer 91 (target person) based on the image data included in the request signal.

In the present embodiment, as described above, the request signal transmitted from management apparatus 1 to mobile terminal 2 includes not only image data but also text data. Thus, display unit 22 displays age verification screen 220 including a text string based on the text data included in the request signal. That is, age verification screen 220 displayed on display unit 22 includes not only the image obtained by capturing customer 91 but also a text string.

Here, “text string” includes, for example, information for suggesting an action (work) to be performed by salesperson 92 (hereinafter, also referred to as “work instruction”). As a specific example, in a case of instructing salesperson 92 to deal with an error of sales system 4 and peripheral devices of sales system 4, a text string for notifying the error of sales system 4, such as an error code of sales system 4, is included in age verification screen 220. In addition, in a case of instructing salesperson 92 to sell and supplement a product such as so-called fast food, for example, a text string representing information of the fast food ordered by customer 91, such as “order for two meat buns is entered”, is included in age verification screen 220.

In addition, as another example of the text string included in age verification screen 220, the text string may include information indicating a specific age as a reference for comparison with the age of the target person in age verification. As a specific example, in age verification related to cigarette sale in Japan, a text string representing a specific age (in this example, an age of 20), such as “Age is 20 or over?”, is included in age verification screen 220.

In addition, in the present embodiment, since mobile terminal 2 is a general-purpose smartphone, display unit 22 and operation unit 23 that receives an operation of salesperson 92 are integrated, for example, like a touch panel display. When an operation (a tap, a swipe, a drag, or the like) of an object such as a button on each screen displayed on display unit 22 is detected by operation unit 23, mobile terminal 2 determines that an object such as a button is operated on the touch panel display. That is, display unit 22 and operation unit 23 perform various display, and also function as a user interface for receiving operation input from salesperson 92.

Here, when receiving the request signal, mobile terminal 2 may immediately display age verification screen 220, or when push notification is performed and then a specific operation (operation of a specific object) is performed by salesperson 92, mobile terminal 2 may display age verification screen 220.

Control unit 24 includes a main computer system, and controls each unit of mobile terminal 2, such as communication unit 21, by causing a processor of the computer system to execute a program recorded in a memory of the computer system. The program may be recorded in advance in the memory, may be provided through an electric communication line such as the Internet, or may be provided by being recorded in a recording medium such as a memory card.

Control unit 24 has a function as response processing unit 241 that transmits a response signal including a result of the age verification to management apparatus 1 by communication unit 21. That is, salesperson 92 (confirmer) who carries mobile terminal 2 can perform age verification of customer 91 (target person) by viewing age verification screen 220 displayed on display unit 22 of mobile terminal 2. The result of the age verification performed by salesperson 92 is received by operation unit 23. When age verification is performed by mobile terminal 2 in this manner, response processing unit 241 includes at least the result of the age verification received by operation unit 23 into a response signal, and transmits the response signal to management apparatus 1. When the response signal is transmitted, control unit 24 ends display of age verification screen 220 on display unit 22.

On the other hand, since age verification system 10 according to the present embodiment includes the plurality of mobile terminals 2A, 2B, and 2C, in order to prevent age verification from being redundantly performed in the plurality of mobile terminals 2A, 2B, and 2C, the following configuration is adopted.

That is, in management apparatus 1, request processing unit 141 is configured to simultaneously transmit the request signal to the plurality of mobile terminals 2A, 2B, and 2C. When a first mobile terminal as one mobile terminal 2 among the plurality of mobile terminals 2A, 2B, and 2C transmits a response signal to management apparatus 1, a notification signal is transmitted from management apparatus 1 to second mobile terminals as mobile terminals 2 different from the first mobile terminal among the plurality of mobile terminals 2A, 2B, and 2C.

As an example, in a case where one mobile terminal 2A among the plurality of mobile terminals 2A, 2B, and 2C transmits a response signal to management apparatus 1, mobile terminal 2A corresponds to the first mobile terminal, and mobile terminals 2B and 2C correspond to each of the second mobile terminals. In this case, when mobile terminal 2A as the first mobile terminal transmits a response signal, a notification signal is transmitted from management apparatus 1 to mobile terminals 2B and 2C as the second mobile terminals. Thereby, other mobile terminals 2B and 2C are notified of a fact that one mobile terminal 2A among the plurality of mobile terminals 2A, 2B, and 2C transmits a response signal to management apparatus 1. Here, the notification signal may include information for identifying the first mobile terminal, that is, in the example, information indicating that a transmission source of a response signal (first mobile terminal) is mobile terminal 2A.

When receiving the notification signal, mobile terminal 2 ends display of age verification screen 220 on display unit 22. That is, in a case where age verification is performed by one first mobile terminal (in the example, mobile terminal 2A) among the plurality of mobile terminals 2A, 2B, and 2C, other second mobile terminals (in the example, mobile terminals 2B and 2C) receive the communication signal and automatically end display of age verification screen 220. Therefore, it is possible to prevent age verification from being redundantly performed in the plurality of mobile terminals 2A, 2B, and 2C.

(2.3) Sales System

Next, sales system 4 will be described in more detail.

As illustrated in FIG. 2, sales system 4 includes first communication unit 41, second communication unit 42, third communication unit 43, control unit 44, storage unit 45, and interface 46.

First communication unit 41 is a communication module that performs bidirectional communication with management apparatus 1 (external communication unit 13) of age verification system 10. First communication unit 41 is connected to age verification system 10 (management apparatus 1) by, for example, a LAN cable.

Second communication unit 42 is a communication module that performs bidirectional communication with shopping basket 5. Second communication unit 42 receives at least product information transmitted from shopping basket 5. In the present embodiment, second communication unit 42 performs communication with shopping basket 5 by optical wireless communication using light such as infrared rays or visible rays as a medium. For optical wireless communication, second communication unit 42 includes an external light transmitting/receiving unit at a position, which corresponds to an inner circumferential surface of recess 82 of counter table 8 and faces a transmitting/receiving unit of shopping basket 5 when shopping basket 5 is placed at the specified position (on the bottom surface of recess 82 of counter table 8).

Here, in a case where a plurality of products 90 are put in shopping basket 5, sales system 4 can collectively acquire a plurality of items of product information from shopping basket 5 by second communication unit 42, the product information being read from the plurality of products 90 by shopping basket 5. In addition, second communication unit 42 not only can collectively receive a plurality of items of product information from shopping basket 5, but also can receive a plurality of items of product information one by one from shopping basket 5.

Third communication unit 43 is a communication module that performs bidirectional communication with settlement processing system 7. Third communication unit 43 is connected to settlement processing system 7 by, for example, a LAN cable. Sales system 4 is able to be constantly synchronized with settlement processing system 7 via third communication unit 43. Further, since settlement processing system 7 can communicate with the store server and the center server, sales system 4 also can communicate with the store server and the center server via settlement processing system 7.

In the present embodiment, price data corresponding to the product information is stored in settlement processing system 7. In addition, information corresponding to product information such as advertisement, discount information, manufacturer information, and recipe information, furthermore, information corresponding to customer information such as a gender, an age, and a preference of a customer, and past purchase history of a customer, are stored in settlement processing system 7 and the store server or the center server. Since sales system 4 communicates with settlement processing system 7 and the store server or the center server, information which is not stored in sales system 4 also can be used by sales system 4.

Control unit 44 includes a main computer system, and controls each unit of sales system 4, such as first communication unit 41, by causing a processor of the computer system to execute a program recorded in a memory of the computer system. The program may be recorded in advance in the memory, may be provided through an electric communication line such as the Internet, or may be provided by being recorded in a recording medium such as a memory card.

Control unit 44 acquires product information from shopping basket 5 by second communication unit 42. Further, control unit 44 acquires price data representing a price of product 90 based on the product information, from settlement processing system 7, by third communication unit 43. Here, “price data” may include contents representing a price (unit price) of a plurality of products 90, and may include contents other than a price. In the present embodiment, the price data also includes, for example, data such as a product name, the number of products, weight data, a consumption tax, and a total amount (settlement amount). Acquisition source of the price data is not limited to settlement processing system 7.

In addition, control unit 44 creates a purchase list using the acquired price data. Here, “purchase list” is a list of information of products 90 including at least price data. In the present embodiment, the purchase list includes a product name, a price (unit price), the number of products, a consumption tax, a total amount (settlement amount), and the like. The created purchase list is displayed, for example, by display device 63.

In addition, control unit 44 can transmit various display data to age verification system 10 (management apparatus 1) or shopping basket 5. The display data transmitted to age verification system 10 is data to be displayed on mobile terminal 2 of age verification system 10, and is transmitted from first communication unit 41. The display data transmitted to shopping basket 5 is data to be displayed on a display of shopping basket 5, and is transmitted from second communication unit 42. The display data transmitted to age verification system 10 includes, for example, information (work instruction) suggesting an action to be performed by salesperson 92, such as error codes of sales system 4 and peripheral devices of sales system 4. The display data transmitted to shopping basket 5 includes, for example, advertisements or recommendation information suitable for customer 91. When transmitting the display data, in order to make it possible to communicate with shopping basket 5 placed at a position distant from the checkout counter, preferably, second communication unit 42 performs communication with shopping basket 5 by wireless communication such as Wi-Fi (registered trademark) or Bluetooth (registered trademark) using radio waves as a medium.

Storage unit 45 stores, for example, an operation log which is a record of work performed by salesperson 92. Since age verification system 10 is a system that performs age verification by receiving and transmitting signals between mobile terminal 2 carried by salesperson 92 and management apparatus 1, for example, it is possible to leave a communication record between mobile terminal 2 and management apparatus 1, as a record obtained by performing work of age verification by salesperson 92. Therefore, sales system 4 acquires a communication record with mobile terminal 2 from management apparatus 1 of age verification system 10, and stores a record (task log) of work (age verification) performed by salesperson 92 in storage unit 45, for each salesperson 92. In addition, in a case where mobile terminal 2 of age verification system 10 is used to deliver a work instruction to salesperson 92, sales system 4 acquires a record of the work instruction transmitted from management apparatus 1 to mobile terminal 2, and stores the acquired record in storage unit 45, for each salesperson 92, as a work log. Further, storage unit 45 may store a gender, an age, a preference, a past purchase history, and the like of customer 91 who uses the store, for only a certain period of time (for example, two weeks) after customer 91 lastly uses the store.

Interface 46 is an interface for connecting sales system 4 and peripheral devices of sales system 4. Packing device 61, supply unit 62, display device 63, input device 64, and sound output unit 65 as peripheral devices are connected to interface 46. Interface 46 has various forms depending on the connection destination, and is connected to packing device 61 and supply unit 62 by, for example, “Ethernet (registered trademark) for control automation technology (EtherCAT) (registered trademark)”.

In addition, in the present embodiment, sales system 4 executes sales processing of a designated product which is not displayed in the store. In other words, sales system 4 performs sales processing of the designated product, in addition to sales processing of product 90 put in shopping basket 5. Here, “designated product” is, for example, a product (so-called fast food) stocked in a store fixture provided around counter table 8, such as a cigarette supplied from supply unit 62, a steamed bun, a fried food, or a fish cake. Specifically, sales system 4 receives an order of a designated product from customer 91 using display device 63, input device 64, sound output unit 65, and the like, and performs sales processing of the designated product. Further, sales system 4 monitors the total stock of the designated product based on a sale history of the designated product.

In addition, sales system 4 has a function of acquiring customer information of customer 91. Here, “customer information” is information of each customer, and may include at least customer identification information (a customer ID) for identifying a customer. Sales system 4 may acquire customer information from various cards such as a membership card, a point card, or a credit card, by a card reader, or may acquire customer information by communication with a mobile information terminal of customer 91, biometric authentication (including face authentication), or the like. Further, sales system 4 is not limited to a configuration of directly acquiring the customer information, and may indirectly acquire the customer information from settlement processing system 7 by communication with settlement processing system 7, the customer information being read from various cards by settlement processing system 7. Alternatively, sales system 4 may indirectly acquire the customer information from shopping basket 5 by communication with shopping basket 5, the customer information being read from various cards by shopping basket 5.

(3) Operation

Hereinafter, an operation of shopping assistance system 100 according to the present embodiment will be described.

(3.1) Basic Operation

First, a basic operation of shopping assistance system 100 during a period from a visit of customer 91 to completion of packing of product 90 will be described.

First, customer 91 who comes the store takes shopping basket 5 from a basket storage place. Thereafter, customer 91 moves inside the store while holding shopping basket 5, and puts products 90 that he or she desires to purchase one by one in shopping basket 5. At this time, shopping basket 5 acquires product information of product 90 by optically reading, for example, a bar code of product 90.

Thereafter, customer 91 places shopping basket 5 in which all the products 90 that he or she desires to purchase are put, at a specified position (on the bottom surface of recess 82 of counter table 8). At this time, for example, a detection unit provided on the bottom surface of recess 82 of counter table 8 detects that shopping basket 5 is placed at the specified position. When receiving a detection result of the detection unit, sales system 4 starts communication with shopping basket 5, and acquires product information from shopping basket 5.

When acquiring the product information, sales system 4 transmits (transfers) the product information from third communication unit 43 to settlement processing system 7. Sales system 4 acquires price data transmitted from settlement processing system 7, as return (a response) to the product information, by third communication unit 43. Further, sales system 4 creates a purchase list, which is a list of information of product 90, using the acquired price data.

At this time, sales system 4 determines whether or not a specific product requiring age verification at the time of sale is included in the purchase list. In the present embodiment, it is assumed that a liquor (a liquor product) is an example of such a specific product. In other words, sales system 4 determines whether or not a liquor is included in products 90 put in shopping basket 5, by referring to the purchase list. When a liquor is present in the purchase list, sales system 4 transmits a start signal from first communication unit 41 to age verification system 10. When receiving the start signal, age verification system 10 starts a series of processing for age verification. An operation of age verification system 10 will be described in detail in a section of “(3.2) Age Verification Operation”.

In a case where age verification on age verification system 10 is passed (that is, in a case where sales system 4 receives a permission signal), or in a case where a liquor is not included in the purchase list, sales system 4 displays a cigarette confirmation screen for confirming the presence or absence of purchase of a cigarette as a specific product, on display device 63. When “cigarette purchase is present” is selected on the cigarette confirmation screen, sales system 4 transmits a start signal from first communication unit 41 to age verification system 10. When age verification on age verification system 10 is passed (that is, when sales system 4 receives a permission signal), sales system 4 displays a cigarette menu screen (refer to FIG. 3) for selecting a brand of cigarettes, on display device 63. Here, in a case where a liquor is present in the purchase list and the age verification is already passed, sales system 4 may immediately display the cigarette menu screen on display device 63 after “cigarette purchase is present” is selected on the cigarette confirmation screen.

This cigarette menu screen has a hierarchical structure, and can be narrowed down by, for example, a brand name, a price range, a tar quantity, and a nicotine quantity. Here, in a case where customer information of customer 91 is acquired by sales system 4, sales system 4 may display a cigarette menu screen, which is narrowed down by a brand name or the like based on the customer information, on display device 63. In the cigarette menu screen, when a specific cigarette is selected, sales system 4 transmits product information of the specific cigarette to supply unit 62. Supply unit 62 selects the specific cigarette from a plurality of cigarettes stocked in supply unit 62, and discharges the specific cigarette to discharge port 621 (refer to FIG. 3). Thereby, customer 91 can receive the cigarette discharged to discharge port 621. In addition, sales system 4 acquires cigarette price data from settlement processing system 7, and adds the acquired cigarette price data to the purchase list.

When supply of a cigarette from supply unit 62 is completed or “cigarette purchase is not present” is selected on the cigarette confirmation screen, sales system 4 proceeds to settlement processing. At this time, sales system 4 displays settlement confirmation screen including the purchase list on display device 63. When settlement start is selected on the settlement confirmation screen, sales system 4 causes settlement processing system 7 to start settlement processing. In the settlement processing, sales system 4 merely functions as a user interface, and settlement itself is performed by settlement processing system 7. Here, a series of processing related to liquor sale from a time when it is determined that a liquor is included in the purchase list to a time when settlement processing of the liquor is completed corresponds to “liquor sales processing”. Similarly, a series of processing related to cigarette sale from a time when “cigarette purchase is present” is selected on the cigarette confirmation screen to a time when settlement processing of the cigarette is completed corresponds to “cigarette sales processing”.

In addition, in a case where age verification on age verification system 10 is failed, sales system 4 stops sales processing of the specific products (in here, a liquor and a cigarette). In the case where age verification on age verification system 10 is failed, a rejection signal is transmitted from age verification system 10 to sales system 4, and a permission signal is not transmitted. Details will be described in a section of “(3.2) Age Verification Operation”. That is, sales system 4 can determine pass/fail of the age verification on age verification system 10, depending on whether or not a permission signal is received. In a case where age verification is failed in the cigarette sales processing, sales system 4 stops the cigarette sales processing, and proceeds to settlement processing. In a case where age verification is failed in the liquor sales processing, sales system 4 does not display the cigarette confirmation screen, stops the liquor sales processing, and immediately proceeds to settlement processing.

After settlement processing is started, sales system 4 causes packing device 61 to execute packing That is, sales system 4 causes settlement processing system 7 to start settlement processing, and then transmits a control signal for starting packing processing to packing device 61. Thereby, during settlement processing of product 90, packing device 61 transfers product 90 from shopping basket 5 to a container. Here, preferably, after packing processing by packing device 61 is completed and settlement processing is completed, customer 91 is allowed to receive the container in which product 90 is put.

In addition, sales system 4 receives an operation (gesture, voice input, etc.) of customer 91 by input device 64, for example, in selection of the presence or absence of purchase of a cigarette, selection of a cigarette in the cigarette sales processing, and the like.

(3.2) Age Verification Operation

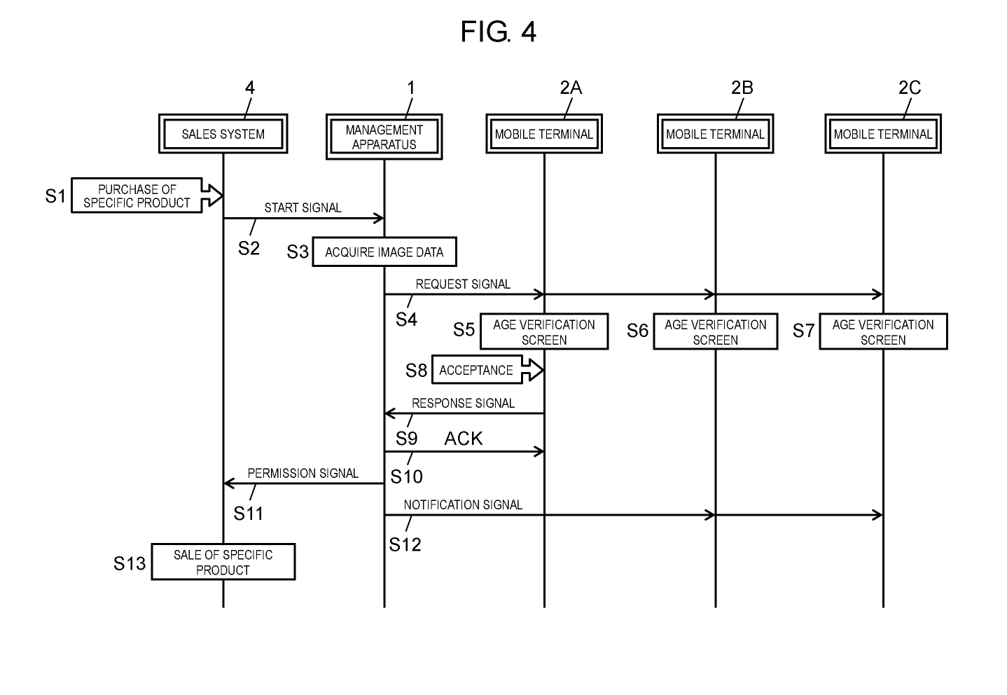

Next, an age verification operation of shopping assistance system 100 will be described in detail with reference to FIG. 4 to FIG. 7. Here, as illustrated in FIG. 5, it is assumed that each of the plurality (in here, three) of salespersons 92A, 92B, and 92C carries mobile terminal 2 in one store. In this case, it is assumed that salesperson 92A carries mobile terminal 2A, salesperson 92B carries mobile terminal 2B, and salesperson 92C carries mobile terminal 2C. In the section of “(3.2) Age Verification Operation”, an operation of shopping assistance system 100 in a state where estimation processing unit 16 is disabled (that is, the first path is selected) will be described.

FIG. 4 is a sequence diagram schematically illustrating an example of processing related to an age verification operation and transmission and reception of signals in shopping assistance system 100.

As illustrated in FIG. 4, in a case where sales system 4 determines that a liquor is included in the purchase list, or in a case where “cigarette purchase is present” is selected on the cigarette confirmation screen, management apparatus 1 receives a start signal from sales system 4. That is, in a case where customer 91 desires to purchase a specific product (a liquor, a cigarette, or the like) requiring age verification at the time of sale (S1), age verification system 10 (management apparatus 1) receives a start signal from sales system 4 (S2), and starts a series of processing for age verification.

When receiving the start signal, management apparatus 1 first acquires image data of an image obtained by capturing customer 91 from imaging device 3 (S3). At this time, management apparatus 1 executes face detection processing by pre-processing unit 15, and transmits a request signal including the image data by request processing unit 141 when a face of customer 91 (target person) is detected. That is, in a state where customer 91 stands at the front of counter table 8 and a face of customer 91 faces forward (counter table 8 side), management apparatus 1 acquires image data from imaging device 3 and transmits a request signal to mobile terminal 2 (S4).

Here, as illustrated in FIG. 5, since there are the plurality of mobile terminals 2A, 2B, and 2C in the store, management apparatus 1 transmits a request signal to the plurality of mobile terminals 2A, 2B, and 2C by wireless communication. Specifically, management apparatus 1 simultaneously (all at once) transmits a request signal to the plurality of mobile terminals 2A, 2B, and 2C by multicast. When receiving the request signal, each of mobile terminals 2 performs incoming call notification by, for example, a ring tone, a light emitting function, or a vibration function, and displays age verification screen 220 as illustrated in FIG. 6, on display unit 22 (S5, S6, and S7 in FIG. 4).

At this time, as illustrated in FIG. 6, age verification screen 220 displayed on mobile terminal 2 includes image 221, OK button 222, NG button 223, text area 224, first cursor 225, second cursor 226, notification button 227, and history button 228. Image 221 is the image of customer 91 (target person) captured by imaging device 3, that is, the image of customer 91 standing in front of counter table 8, and is displayed by using the image data included in the request signal. OK button 222 is an object that salesperson 92 operates (taps) when salesperson 92 determines that an age of customer 91 is equal to or higher than a specific age (that is, a result of the age verification is “pass”). NG button 223 is an object that salesperson 92 operates (taps) when salesperson 92 determines that an age of customer 91 is lower than the specific age (that is, a result of the age verification is “fail”). Text area 224 is an area for displaying a text string, and is displayed using the text data included in the request signal. In the example of FIG. 6, in text area 224, a text string “Age is 20 or over?” is displayed as a text string including information indicating the specific age as a reference for comparison with the age of the target person in age verification. First cursor 225 and second cursor 226 are objects that salesperson 92 operates (taps) when salesperson 92 switches image 221. Notification button 227 is an object that salesperson 92 operates (taps) when salesperson 92 switches display of mobile terminal 2 from age verification screen 220 to a notification screen. The notification screen is a screen representing information (work instruction) suggesting an action (work) to be performed by salesperson 92 according to, for example, an instruction (a start signal) from sales system 4. A specific example of the work instruction will be described later. History button 228 is an object that salesperson 92 operates (taps) when salesperson 92 confirms a history such as a work log on mobile terminal 2.

Thereby, salesperson 92 who carries mobile terminal 2 can perform age verification by viewing image 221 of customer 91 displayed on display unit 22. Here, as an example, as illustrated in FIG. 5, it is assumed that salesperson 92A performs age verification among salesperson 92A in the process of inventory work, salesperson 92B in the process of cleaning, and salesperson 92C in the process of customer service. In this case, salesperson 92A performs age verification by viewing age verification screen 220 displayed on mobile terminal 2A carried by salesperson 92A himself or herself. At this time, in a case where it is difficult to determine the age of customer 91 from image 221 by a reason that a face of customer 91 faces downward in image 221 or by other reasons, salesperson 92A can switch image 221 by operating first cursor 225 or second cursor 226. When first cursor 225 is operated, image 221 is switched to a one-frame previous (old) image in time series. When first cursor 225 is operated, image 221 is switched to a one-frame next (new) image in time series. In order to switch image 221 when first cursor 225 or second cursor 226 is operated, a plurality of pieces of image data are required. The plurality of pieces of image data may be included in the request signal and collectively transmitted from management apparatus 1 to mobile terminal 2, or may be transmitted from management apparatus 1 to mobile terminal 2 one by one each time first cursor 225 or second cursor 226 is operated.

For example, salesperson 92A as a confirmer can confirm a face of customer 91 as a target person who is standing in front of counter table 8, by image 221 displayed on mobile terminal 2A, even at a position distant from counter table 8 or from a blind spot of counter table 8. At this time, when salesperson 92A determines that an age of customer 91 is equal to or higher than the specific age, salesperson 92A performs an operation of “acceptance” by operating OK button 222. Thereby, mobile terminal 2A receives the operation of “acceptance” from salesperson 92A (S8 of FIG. 4), and transmits a response signal including the result of the age verification (in this case, “pass”) to management apparatus 1 (S9).

When management apparatus 1 receives the response signal indicating pass of the age verification from mobile terminal 2A, management apparatus 1 transmits an acknowledgment (ACK) to mobile terminal 2A (S10). Until the acknowledgment from management apparatus 1 is received, mobile terminal 2A repeatedly transmits the response signal by a prescribed number of times of re-transmission as an upper limit. When the acknowledgment from management apparatus 1 is received, mobile terminal 2A ends transmission of the response signal, and ends display of age verification screen 220 on display unit 22.

After transmitting the acknowledgment, management apparatus 1 transmits a permission signal to sales system 4 (S11). Further, management apparatus 1 transmits a notification signal to mobile terminals 2B and 2C (that is, second mobile terminals) other than mobile terminal 2A (that is, first mobile terminal) that is a transmission source of the response signal (S12). Here, management apparatus 1 simultaneously (all at once) transmits a notification signal to mobile terminals 2B and 2C by multicast. When receiving the notification signal, mobile terminals 2B and 2C end display of age verification screen 220 on display unit 22.

When receiving the permission signal, sales system 4 determines that the age verification on age verification system 10 is passed, and continues sales processing of the specific product (a liquor, a cigarette, or the like) (S13). For example, in a case where the age verification at the time of sale of a liquor is passed, sales system 4 displays a cigarette confirmation screen on display device 63. For example, in a case where the age verification at the time of sale of a cigarette is passed, sales system 4 displays a cigarette menu screen on display device 63.

As described above, FIG. 4 exemplifies an operation in a case where age verification on age verification system 10 is passed. On the other hand, in a case where age verification on age verification system 10 is failed, shopping assistance system 100 operates as follows.

That is, when salesperson 92A determines that an age of customer 91 is lower than the specific age, salesperson 92A performs an operation of “rejection” by operating NG button 223. In this case, mobile terminal 2A receives the operation of “rejection” from salesperson 92A, and transmits a response signal including the result of the age verification (in this case, “fail”) to management apparatus 1. Thereafter, management apparatus 1 transmits an acknowledgment, and mobile terminal 2A ends display of age verification screen 220.

After transmitting the acknowledgment, management apparatus 1 transmits a non-permission signal to sales system 4. Further, management apparatus 1 transmits a notification signal to mobile terminals 2B and 2C, and mobile terminals 2B and 2C end display of age verification screen 220. When receiving the rejection signal, sales system 4 determines that the age verification on age verification system 10 is failed, and stops sales processing of the specific product (a liquor, a cigarette, or the like). For example, in a case where age verification is failed in the cigarette sales processing, sales system 4 stops the cigarette sales processing, and proceeds to settlement processing. In a case where age verification is failed in the liquor sales processing, sales system 4 stops the liquor sales processing, and immediately proceeds to settlement processing.

In addition, even in a case where a certain period of time elapses (timeout) while neither the permission signal nor the rejection signal is received from management apparatus 1 after sales system 4 transmits the start signal, age verification on age verification system 10 is failed. In other words, in a case where neither of the plurality of salespersons 92A, 92B, and 92C performs age verification within a certain period of time, sales system 4 determines that the age verification on age verification system 10 is failed, and stops sales processing of the specific product (a liquor, a cigarette, or the like).

That is, in a case where customer 91 purchases a specific product (a liquor, a cigarette, or the like), for age verification, sales system 4 temporarily suspends sales processing, and enters a standby state without restarting the sales processing until a permission signal is received from age verification system 10. In a case where age verification on age verification system 10 is failed, preferably, sales system 4 displays a message such as “age verification is failed” on display device 63.

On the other hand, depending on a specific product, in age verification, a specific age as a reference for comparison with an age of a target person may be different from a specific age in other specific products. For example, in Japan, a specific age for age verification related to sale of a liquor, a cigarette, and the like is 20, and a specific age for age verification related to sale of adult magazines is 18. In the present embodiment, a text string representing a specific age (in this example, an age of 20) such as “Age is 20 or over?” is displayed in text area 224 of age verification screen 220, and thus, an age (a specific age) as a reference of age verification is notified to salesperson 92 who performs age verification. That is, at the time of sale of a specific product requiring a specific age of 18 (for example, an adult magazine), a text string such as “Age is 18 or over?” is displayed in text area 224 of age verification screen 220.

Therefore, by viewing age verification screen 220 displayed on mobile terminal 2, salesperson 92 can perform age verification according to the specific product. Here, the text string displayed on age verification screen 220 may represent a specific age, and for example, may be a text string indirectly representing a specific age by representing a specific product requiring age verification (in this example, a cigarette), such as “permit cigarette sale?”.

Preferably, the text data to be included in the request signal, that is, contents of the text string to be displayed on age verification screen 220 is determined, for example, by an instruction (a start signal) from sales system 4. That is, when sales system 4 transmits a start signal to age verification system 10 (management apparatus 1), preferably, the start signal includes information indicating a specific age (a specific age itself, or information of a specific product requiring age verification).

In addition, in text area 224 of age verification screen 220, a text string, which represents information (work instruction) suggesting an action (work) to be performed by salesperson 92 according to, for example, an instruction (a start signal) from sales system 4, may be displayed. As a specific example, a text string for notifying an error of sales system 4, such as an error code of sales system 4, or a text string representing information of fast food ordered by customer 91, such as “order for two meat buns is entered” is displayed in text area 224 of age verification screen 220. Here, in a case where there is a work instruction requiring serving for customer 91, for example, sale of fast food or the like, salesperson 92 can specify customer 91 to be served by viewing image 221 of age verification screen 220. For example, in a case where a text string of “order for two meat buns is entered” is displayed in text area 224, salesperson 92 can recognize that he or she needs to sell (provide) “two meat buns” to customer 91 appearing in image 221 of age verification screen 220, from age verification screen 220.

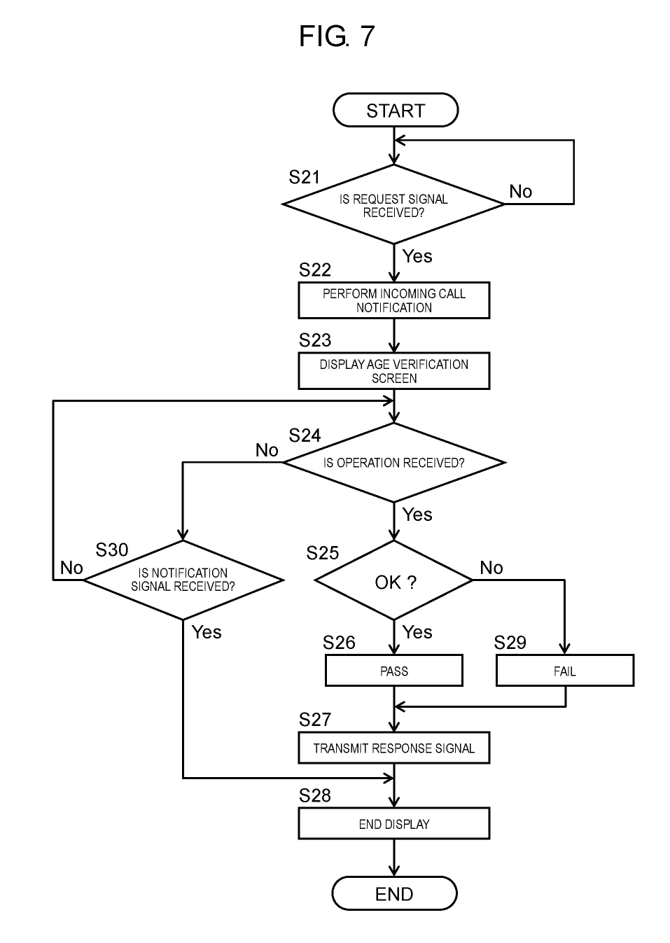

On the other hand, focusing on mobile terminal 2, the above-described age verification operation is as illustrated in FIG. 7. FIG. 7 is a flowchart illustrating an operation of mobile terminal 2.

That is, as illustrated in FIG. 7, in a normal operation, mobile terminal 2 is in a reception waiting state for waiting a request signal from management apparatus 1 (S21). In the reception waiting state, when receiving a request signal (Yes in S21), mobile terminal 2 performs incoming call notification for notifying salesperson 92 of an incoming call (S22). Thereafter, mobile terminal 2 displays age verification screen 220 by display unit 22 (S23), and enters an operation waiting state for waiting an operation of salesperson 92 by operation unit 23 (S24).

In the operation waiting state, when receiving an operation by operation unit 23 (Yes in S24), mobile terminal 2 determines which one of OK button 222 and NG button 223 is operated (S25).

When OK button 222 is operated (Yes in S25), mobile terminal 2 determines that the age verification is passed (S26), and transmits a response signal including the result of the age verification (in this case, “pass”) to management apparatus 1 (S27). Thereafter, when receiving an acknowledgment from management apparatus 1, mobile terminal 2 ends transmission of the response signal, and ends display of age verification screen 220 on display unit 22 (S28).

On the other hand, when NG button 223 is operated (No in S25), mobile terminal 2 determines that the age verification is failed (S29), transmits a response signal including the result of the age verification (in this case, “fail”) to management apparatus 1 (S27), and ends display of age verification screen 220 (S28).

In addition, in the operation waiting state, mobile terminal 2 continues the operation waiting state while periodically determining whether or not a notification signal is received (S30). When receiving a notification signal (Yes in S30), mobile terminal 2 ends the operation waiting state, and ends display of age verification screen 220 on display unit 22 (S28). In addition, even in a case where a certain period of time elapses (timeout) without receiving the notification signal after the operation waiting state is started (No in S30), mobile terminal 2 ends display of age verification screen 220 on display unit 22 (S28).

On the other hand, age verification system 10 may omit the age verification operation by using a record (log) of age verification performed in the past. Specifically, by storing a record of age verification performed in the past for each customer 91 in correlation with the customer information in settlement processing system 7, and the store server or the center server, for customer 91 who is already “passed” in age verification, the age verification operation may be omitted. That is, sales system 4 or age verification system 10 refers to a record of past age verification of customer 91 based on the customer information of customer 91, and when the record of the age verification is “pass”, omits new age verification by using the result of the past age verification (pass).

Further, in the case of using the record (log) of age verification performed in the past, preferably, the record of age verification performed in the past and the image data of the image used at that time (hereinafter, referred to as “reference image”) are stored in correlation with each other. In this case, only in a case where “face” of the image of customer 91 acquired from imaging device 3 matches with “face” of the reference image corresponding to the customer information of customer 91, age verification system 10 uses the result of the past age verification. Thereby, it is possible to prevent age verification from being illegally omitted due to so-called “impersonation”, which means that a person other than the customer himself/herself uses a membership card or the like.

Here, preferably, a period of time in which the record of age verification performed in the past, the image data of the reference image, and the like are stored in settlement processing system 7 or the like is limited to a certain period of time in the past (for example, the last two weeks).

(3.3) Estimation Processing

Next, an age verification operation of shopping assistance system 100 in a state where estimation processing unit 16 is enabled (that is, the second path is selected) will be described. Hereinafter, redundant explanation of substantially the same operation as the operation described in the section of “(3.2) Age Verification Operation” may be omitted.

When receiving the start signal, acquisition unit 12 of management apparatus 1 first acquires image data of an image obtained by capturing customer 91 from imaging device 3. At this time, management apparatus 1 executes estimation processing of an age of customer 91 (target person) by estimation processing unit 16. That is, management apparatus 1 extracts feature data of, for example, eyes, a nose, a mouth, and the like (such as positions, tints, and the number of wrinkles) from the image data acquired from imaging device 3, calculates an age of customer 91 based on the feature data, as an estimated age, and determines whether or not the estimated age is equal to or higher than a specific age. When the estimation processing is completed, management apparatus 1 transmits a request signal including the estimation result of estimation processing unit 16, in addition to the image data, by request processing unit 141. That is, management apparatus 1 transmits a request signal including the image data and the estimation result of estimation processing unit 16, to mobile terminal 2.

In this case, as in the example of FIG. 6, age verification screen 220 displayed on mobile terminal 2 includes image 221, OK button 222, NG button 223, and text area 224. Here, unlike the example of FIG. 6, a text string including contents based on the estimation result of estimation processing unit 16 is displayed in text area 224. In a case where the estimation result of estimation processing unit 16 indicates that the estimated age is equal to or higher than the specific age, for example, a text string “Age is 20 or over. Is this correct?” is displayed in text area 224. Salesperson 92 who carries mobile terminal 2 views age verification screen 220, and determines whether to accept or reject the estimation result of estimation processing unit 16.

That is, in a case where salesperson 92 accepts the estimation result of estimation processing unit 16, salesperson 92 performs an operation of “acceptance” by operating OK button 222. Thereby, mobile terminal 2 receives the operation of “acceptance” from salesperson 92, and transmits a response signal including the result of the age verification (in this case, “pass”) to management apparatus 1. On the other hand, in a case where salesperson 92 rejects the estimation result of estimation processing unit 16, salesperson 92 performs an operation of “rejection” by operating NG button 223. In this case, mobile terminal 2 receives the operation of “rejection” from salesperson 92, and transmits a response signal including the result of the age verification (in this case, “fail”) to management apparatus 1.

In addition, in a case where the estimation result of estimation processing unit 16 indicates that the estimated age is lower than the specific age, for example, a text string “Age is under 20. Is this correct?” is displayed in text area 224. In this case, when salesperson 92 performs an operation of “acceptance” for the estimation result by operating OK button 222, mobile terminal 2 transmits a response signal including the result of the age verification (in this case, “fail”) to management apparatus 1. On the other hand, when salesperson 92 performs an operation of “rejection” for the estimation result by operating NG button 223, mobile terminal 2 transmits a response signal including the result of the age verification (in this case, “pass”) to management apparatus 1.

As described above, in a case where the estimation result of estimation processing unit 16 indicates that the age of customer 91 is equal to or higher than the specific age, when salesperson 92 accepts the estimation result, the age verification is passed, and when salesperson 92 rejects the estimation result, the age verification is failed. Therefore, the estimation result of estimation processing unit 16 is not used for immediately determining pass/fail of the age verification of age verification system 10, and is used for assisting age verification to be performed on mobile terminal 2 by salesperson 92.

(4) Modification Examples

The embodiment is merely an example of the present invention, and the present invention is not limited to the embodiment. In addition to the embodiment, various modifications may be made according to a design or the like without departing from the spirit of the inventions.

(4.1) First Modification Example

First, age verification system 10 according to a first modification example of the embodiment will be described.

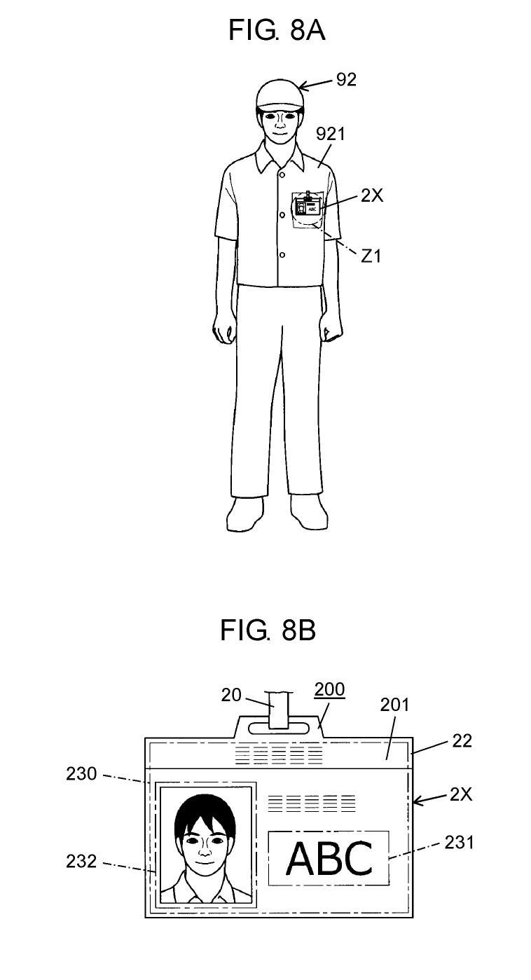

Age verification system 10 according to the present modification example is different from age verification system 10 according to the embodiment in a configuration of mobile terminal. That is, in the first modification example, as illustrated in FIG. 8A and FIG. 8B, mobile terminal 2X is not a general-purpose smartphone as in the embodiment, and is a name tag type dedicated terminal. FIG. 8B is an enlarged view of region Z1 in FIG. 8A. Hereinafter, the same components as in the embodiment are denoted by the same reference numerals, and description thereof may be appropriately omitted.

As illustrated in FIG. 8A, mobile terminal 2X according to the present modification example is directly or indirectly attached to salesperson 92 (confirmer). In the example of FIG. 8A, mobile terminal 2X is indirectly attached to salesperson 92 by being attached to clothes 921 of salesperson 92 (in the example of FIG. 8A, a shirt). Here, mobile terminal 2X has a function as a name tag for representing identification information of salesperson 92 to customer 91. Therefore, mobile terminal 2X is attached to salesperson 92 in a state where at least display surface 201 (refer to FIG. 8B) of display unit 22 (refer to FIG. 8B) can be viewed from the front of salesperson 92. In the example of FIG. 8A, mobile terminal 2X is attached to salesperson 92 at a position of a chest pocket of clothes 921 in a state where display surface 201 faces forward.

More specifically, as illustrated in FIG. 8B, mobile terminal 2X includes attachment portion 20 and body 200. Attachment portion 20 is a member for directly or indirectly attaching mobile terminal 2X to salesperson 92 as a confirmer. Body 200 is a main body of mobile terminal 2X, and is attached to salesperson 92 by attachment portion 20. In the present modification example, attachment portion 20 is, for example, a clip, and is detachably attached to clothes 921 by clipping a portion (chest pocket) of clothes 921. In addition, body 200 is formed, for example, in a rectangular card shape. Body 200 is attached to clothes 921 by attachment portion 20 in a state where an upper end portion of body 200 is held by attachment portion 20. A lower end portion of body 200 is not particularly fixed, and body 200 can rotate on the upper end portion, which is held by attachment portion 20, as a fulcrum. Therefore, as will be described in detail later, body 200 can be switched between a state where a front surface (display surface 201) thereof faces forward and a state where the front surface (display surface 201) faces upward.

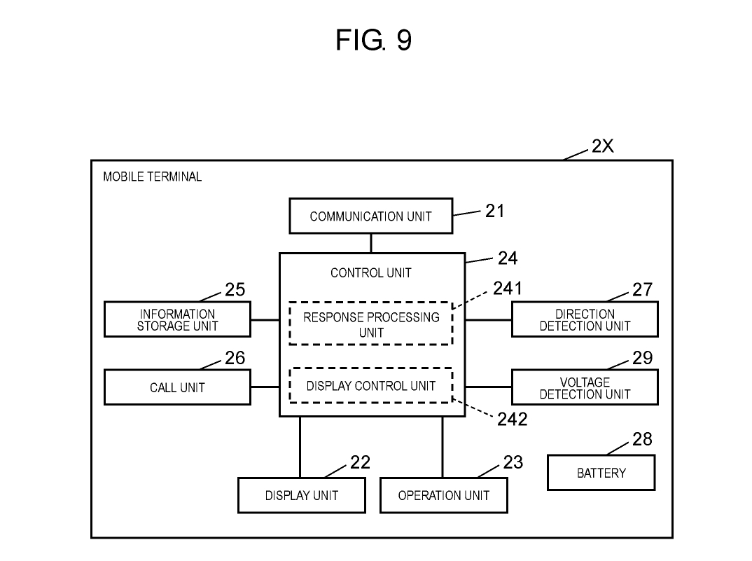

Similar to mobile terminal 2 according to the embodiment, body 200 is provided with communication unit 21, display unit 22, operation unit 23, control unit 24, and the like (refer to FIG. 9). Here, substantially the entire area of the front surface of body 200 is display surface 201 of display unit 22. In mobile terminal 2X according to the present modification example, display unit 22 is configured to display at least name tag screen 230 on display surface 201, that is, substantially the entire area of the front surface of body 200. Name tag screen 230 is a screen for causing mobile terminal 2X to function as a name tag, and includes at least identification information. Here, “identification information” is information for identifying a confirmer (salesperson 92) to which mobile terminal 2X is attached, and includes, for example, a name (first name), a face photo, a portrait, a nickname, or an employee code of salesperson 92. In the example of FIG. 8B, name tag screen 230 displayed by display unit 22 includes name area 231 and photo area 232. Name area 231 is an area for displaying a text string representing a name of salesperson 92. In the example of FIG. 8B, in name area 231, a text string “ABC” is displayed as a text string representing a name. Here, the name displayed in name area 231 may be at least one of a last name and a first name, and is generally only a last name. Photo area 232 is an area for displaying a face photo of salesperson 92. Here, the screen configuration of name tag screen 230 illustrated in FIG. 8B is merely an example, and, for example, name tag screen 230 may not include at least one of name area 231 and photo area 232.

Here, display unit 22 is a memory-type display such as electrophoretic electronic paper. That is, display unit 22 is a memory-type display that maintains display of a screen displayed by energizing display unit 22 until at least a predetermined time elapses from a stop timing of the energization. Here, the predetermined time is, preferably, for example, approximately several seconds (a time equal to or longer than two seconds and equal to or shorter than ten seconds). Therefore, mobile terminal 2X can stop energization to display unit 22 except for a time of updating the displayed screen, and thus, it is possible to suppress consumption of battery 28 (refer to FIG. 9). Here, as an example, display unit 22 is a monochromatic display. On the other hand, display unit 22 may be a color display. In addition, display unit 22 displays a still image. On the other hand, display unit 22 may display a moving image (including a single frame moving image).

As illustrated in FIG. 9, mobile terminal 2X according to the present modification example includes information storage unit 25, call unit 26, direction detection unit 27, battery 28, and voltage detection unit 29, in addition to communication unit 21, display unit 22, operation unit 23, and control unit 24. Further, control unit 24 also has a function as display control unit 242, in addition to the function as response processing unit 241. Display control unit 242 controls display unit 22.

Information storage unit 25 is configured with, for example, a nonvolatile memory. Information storage unit 25 may be incorporated in body 200, or may be an external storage device that can be removed from body 200, such as a memory card. In information storage unit 25, information required for displaying at least name tag screen 230, that is, identification information is stored. The identification information stored in information storage unit 25 can be appropriately rewritten. In addition, a plurality of pieces of identification information for the plurality of salespersons 92 are stored in information storage unit 25. Display control unit 242 may read one piece of identification information from the plurality of pieces of identification information, and display name tag screen 230 on display unit 22.

Similarly to mobile terminal 2 (smartphone) of the embodiment, in a case where there is an incoming call, for example, in a case where a request signal is received from management apparatus 1, call unit 26 performs incoming call notification for notifying salesperson 92 of the incoming call. Specifically, call unit 26 performs incoming call notification by, for example, a ring tone, a light emitting function, or a vibration function. Here, call unit 26 may change, for example, an operation pattern such as a ring tone, a light emitting function, or a vibration function, depending on contents of the incoming call. As an example, at a time when a request signal is received from management apparatus 1 and a time when other signals are received, a pattern of the ring tone or a vibration pattern of the vibration function may be changed. Thereby, salesperson 92 can recognize urgency or priority of the incoming call without viewing display of display unit 22.

Direction detection unit 27 has a function of detecting a direction of display unit 22. Specifically, direction detection unit 27 includes, for example, a sensor such as an acceleration sensor or a gyro sensor, detects a pose of display unit 22, and outputs the detection result to control unit 24. Thereby, control unit 24 can determine whether display unit 22 faces forward (a front side when viewed from salesperson 92) or faces upward (a face side of salesperson 92). Control unit 24 determines whether or not display unit 22 faces forward, for example, based on whether a normal line of display surface 201 is within a predetermined allowable range with respect to a horizontal direction. That is, when the normal line of display surface 201 is within the allowable range with respect to the horizontal direction, it is determined that display unit 22 (display surface 201 of display unit 22) faces forward. The allowable range is, for example, approximately ±30 degrees.

Here, display control unit 242 switches between a first mode and a second mode according to the direction of display unit 22. The first mode is an operation mode in which name tag screen 230 is displayed on display unit 22. The second mode is an operation mode in which a screen other than name tag screen 230, for example, age verification screen 220, is displayed on display unit 22. In this case, preferably, when display unit 22 (display surface 201 of display unit 22) faces forward, display control unit 242 operates in the first mode, and when display unit 22 (display surface 201 of display unit 22) faces upward, display control unit 242 operates in the second mode.

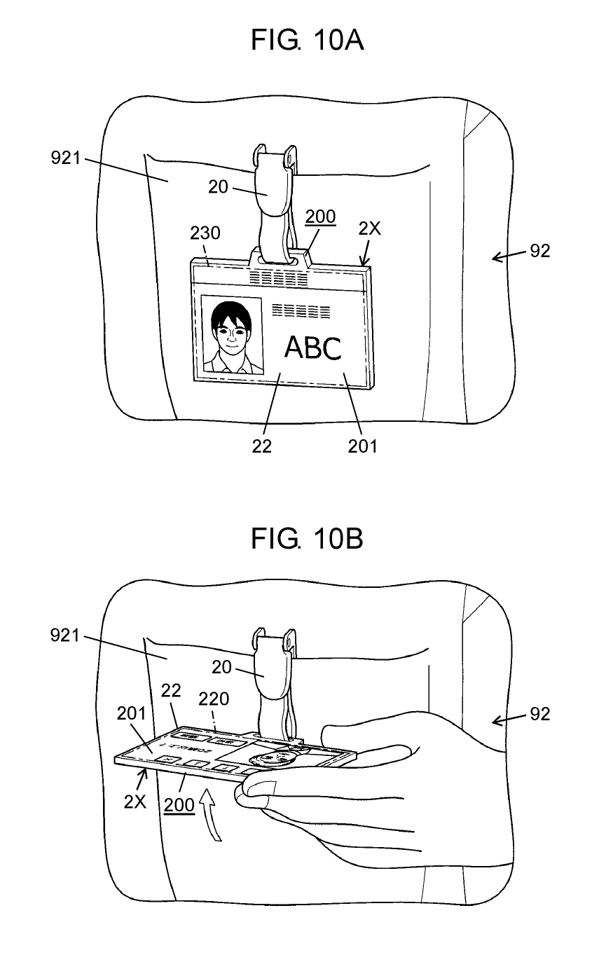

According to this configuration, as illustrated in FIG. 10A, in a state where display surface 201 faces forward, that is, in a state where display surface 201 faces the front when viewed from salesperson 92, display unit 22 displays name tag screen 230. Therefore, for customer 91 at the front of salesperson 92, mobile terminal 2X can be viewed, for example, as a name tag. On the other hand, as illustrated in FIG. 10B, in a state where display surface 201 faces upward, that is, in a state where display surface 201 faces toward the face of salesperson 92, display unit 22 displays a screen other than name tag screen 230, in here, age verification screen 220. Therefore, salesperson 92 can cause mobile terminal 2X to display age verification screen 220, for example, by only rotating (tilting) body 200 with his/her hand such that display surface 201 faces upward, in response to the incoming call notification. Accordingly, salesperson 92 can perform age verification by viewing age verification screen 220 displayed on display unit 22.

In addition, in a state illustrated in FIG. 10B, display unit 22 displays age verification screen 220 such that the upper end portion side (attachment portion 20 side) of body 200 faces downward in the screen. In this manner, preferably, in the first mode and the second mode, display control unit 242 vertically reverses the screen displayed on display unit 22.

Battery 28 serves as a power source for operations of each unit of mobile terminal 2X. In other words, mobile terminal 2X is configured to operate by power supply from battery 28. In the present modification example, battery 28 is a rechargeable secondary battery. Battery 28 may be incorporated in body 200, or may be removably inserted into body 200. Charging of battery 28 is performed at a back office of the store or the like when mobile terminal 2X is not in use.

Voltage detection unit 29 detects an output voltage of battery 28 and outputs the detection result to control unit 24. Thereby, control unit 24 can estimate a remaining capacity of battery 28 based on the detection result of voltage detection unit 29. The remaining capacity of battery 28 estimated by control unit 24 may be displayed on display unit 22 by display control unit 242.

Here, in a case where at least the remaining capacity of battery 28 is equal to or less than a threshold value, display unit 22 displays name tag screen 230. That is, when the estimated remaining capacity of battery 28 is equal to or less than the threshold value, control unit 24 forcibly displays name tag screen 230 on display unit 22 by display control unit 242. This makes it possible to forcibly rewrite the screen of display unit 22 to name tag screen 230, for example, before the remaining capacity of battery 28 falls below the minimum value required for rewriting the screen of display unit 22. According to this configuration, in a case where display unit 22 is a memory-type display as described above, even after the remaining capacity of battery 28 is lowered and mobile terminal 2X is turned off, display unit 22 can maintain display of name tag screen 230. Therefore, mobile terminal 2X can maintain the function as a name tag.

In addition, similar to mobile terminal 2 (smartphone) according to the embodiment, operation unit 23 of mobile terminal 2X may be realized by a touch panel disposed overlapping with display unit 22, or may be realized by another input device. That is, operation unit 23 may be, for example, a sheet-shaped pressure sensor (pressure-sensitive sensor) incorporated in body 200, a mechanical switch provided on body 200, or the like. When operation unit 23 is a sheet-shaped pressure sensor, salesperson 92 can operate operation unit 23 by pressing display surface 201. In this case, it is possible to reduce a thickness of body 200.

Further, mobile terminal 2X may display name tag screen 230 including information other than the identification information on display unit 22. For example, name tag screen 230 may include advertisements, discount information, recommendation information, and the like. Thereby, mobile terminal 2X can function as a digital signage.

On the other hand, as another type other than the name tag type, the mobile terminal can adopt the following types: a type in which the mobile terminal is worn on clothes 921 or directly worn on a part of a person's body such as an arm, a waist, a shoulder, or a wrist; and a type in which the mobile terminal is stored in a pocket of clothes 921 and is taken out of the pocket only in use. Here, in a case of the former type, for example, in a customer service or the like, when salesperson 92 (confirmer) wears the mobile terminal, an appearance may become bad, and as a result, the former type may not be preferred. In addition, in a case of wearing the mobile terminal on a wrist, and in a case of the latter type, for example, in a store offering food products, the type may not be preferred for reasons of hygiene. Further, in the latter type, a risk that salesperson 92 loses the mobile terminal also increases. On the other hand, name-tag-type mobile terminal 2X according to the present modification example has a good appearance. In addition, there is no hygiene problem, and a risk of loss is also reduced.

In addition, as in name-tag-type mobile terminal 2X according to the present modification example, preferably, mobile terminal 2X is made as small and light as possible. Thereby, it is possible to reduce an influence (burden) on ordinary work of salesperson 92 according to application of age verification system 10 (mobile terminal 2X).

In the first modification example, it is not essential that display unit 22 is a memory-type display. In other words, display unit 22 of mobile terminal 2X may be, for example, a display configured to end screen display according to stop of energization, such as a liquid crystal display (LCD).

In addition, in the first modification example, it is not an essential configuration that display unit 22 displays name tag screen 230 in the case where the remaining capacity of battery 28 is equal to or less than the threshold value. That is, in the case where the remaining capacity of battery 28 is equal to or less than the threshold value, display unit 22 may display a screen other than name tag screen 230, for example, age verification screen 220.

In addition, in the first modification example, it is not an essential function that display control unit 242 has a function of automatically switching between the first mode and the second mode according to a direction of display unit 22. For example, display control unit 242 may switch between the first mode and the second mode according to an operation on operation unit 23.

In addition, in the first modification example, attachment portion 20 is not limited to a clip, and may be, for example, a neck strap, a safety pin, a snap (push hook), or the like. When attachment portion 20 is a neck strap, mobile terminal 2X is directly attached to salesperson 92 so as to be hung from a neck of salesperson 92. Further, attachment portion 20 may be integrated with clothes 921, such as being sewn on clothes 921.

In addition, in the first modification example, direction detection unit 27 is not limited to a sensor such as an acceleration sensor or a gyro sensor, and may be realized by, for example, using a mercury switch or the like.

In addition, in the first modification example, battery 28 is not limited to a secondary battery, and may be, for example, a primary battery, a solar battery, or the like. Battery 28 may not be included in components of mobile terminal 2X.

In addition, as in the first modification example, in name-tag-type mobile terminal 2X, it is not essential that age verification screen 220 to be displayed includes image 221.

(4.2) Second Modification Example

Next, age verification system 10 according to a second modification example of the embodiment will be described.

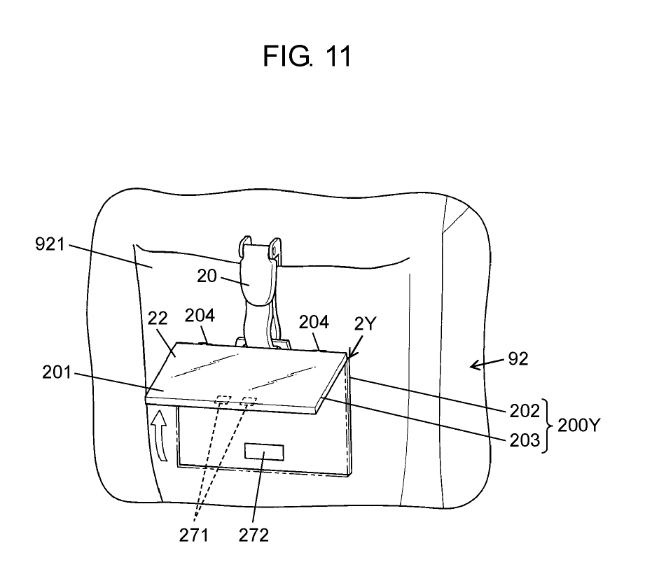

Age verification system 10 according to the present modification example is different from age verification system 10 according to the first modification example in a configuration of mobile terminal. That is, in the second modification example, as illustrated in FIG. 11, mobile terminal 2Y is a name tag type dedicated terminal having openable/closable body 200Y. Hereinafter, the same components as in the first modification example are denoted by the same reference numerals, and description thereof may be appropriately omitted.

In mobile terminal 2Y according to the present modification example, as illustrated in FIG. 11, body 200Y includes base 202 and cover 203. As an example, base 202 is attached to clothes 921 by attachment portion 20 in a state where an upper end portion of base 202 is held by attachment portion 20. Cover 203 is attached to base 202 so as to cover a front surface of base 202. An upper end portion of cover 203 is joined to the upper end portion of base 202 by a pair of hinge portions 204. Thereby, cover 203 can rotate on the pair of hinge portions 204 as fulcrums between a base-closing position at which the front surface of base 202 is covered and a base-opening position at which the front surface of base 202 is opened.

Here, the function of body 200 of mobile terminal 2X according to the first modification example is integrated into cover 203 in the present modification example. That is, the front surface of cover 203 is display surface 201 of display unit 22. In a state where cover 203 is at the base-closing position, display unit 22 (display surface 201 of display unit 22) faces forward, and in a state where cover 203 is at the base-opening position, display unit 22 (display surface 201 of display unit 22) faces upward.

In addition, in the present modification example, direction detection unit 27 (refer to FIG. 9) is realized by a pair of contacts 271 and conductive plate 272. The pair of contacts 271 is provided on a back surface of cover 203. Conductive plate 272 is provided on a front surface of base 202 at a position facing the pair of contacts 271. In a state where cover 203 is at the base-closing position, the pair of contacts 271 become conductive via conductive plate 272. On the other hand, in a state where cover 203 is at the base-opening position, the pair of contacts 271 become nonconductive. Therefore, direction detection unit 27 detects an opening/closing state of body 200, that is, a direction of display unit 22, according to the conduction state between the pair of contacts 271.

According to the configuration of the present modification example, mobile terminal 2Y can detect a direction of display unit 22 with a simple configuration, for example, without using a sensor such as an acceleration sensor or a gyro sensor.

In the second modification example, it is not essential that direction detection unit 27 includes a pair of contacts 271 and conductive plate 272. That is, for example, mobile terminal 2Y may detect the opening/closing state of body 200 by, for example, a limit switch provided on the front surface of base 202, a brightness sensor provided on the front surface of base 202, or a rotary switch incorporated in hinge portion 204.

(4.3) Other Modification Examples

Hereinafter, modification examples other than the first modification example and the second modification example of the embodiment will be listed.

It is not an essential configuration for age verification system 10 that acquisition unit 12 is provided in management apparatus 1, and acquisition unit 12 may be appropriately omitted.

In addition, it is not an essential configuration for age verification system 10 that external communication unit 13 is provided in management apparatus 1, and external communication unit 13 may be appropriately omitted.

In addition, it is not an essential configuration for age verification system 10 that imaging device 3 is provided. Imaging device 3 may not be included in the components of age verification system 10, or imaging device 3 may be omitted. In a case where imaging device 3 is omitted, management apparatus 1 may acquire image data of an image obtained by capturing customer 91 by, for example, a camera of a smartphone owned by customer 91 (target person), or a camera of another system different from age verification system 10 such as a security system.

In addition, it is not an essential configuration for age verification system 10 that each of pre-processing unit 15 and estimation processing unit 16 is provided, and pre-processing unit 15 or estimation processing unit 16 may be appropriately omitted. In a case where pre-processing unit 15 is omitted, estimation processing unit 16 is connected to acquisition unit 12, the image data acquired from imaging device 3 by acquisition unit 12 is directly input from acquisition unit 12 to estimation processing unit 16. In a case where pre-processing unit 15 is omitted, even when image data of an image in which a face of customer 91 does not appear is transmitted to mobile terminal 2, salesperson 92 switches image 221 by operating first cursor 225 or second cursor 226, and thus salesperson 92 can confirm image 221 in which the face of customer 91 appears.

Further, pass/fail of age verification of age verification system 10 may immediately determined by the estimation result of estimation processing unit 16 without requiring acceptance of salesperson 92 (confirmer) on the estimation result of estimation processing unit 16. That is, in a case where the estimation result of estimation processing unit 16 indicates that the age of customer 91 is equal to or higher than the specific age, regardless of whether or not salesperson 92 accepts the estimation result, the age verification is passed. In this case, the age verification on age verification system 10 is completed on management apparatus 1 without passing through mobile terminal 2. Therefore, even in a situation where any salesperson 92 cannot respond to a call from management apparatus 1, age verification on age verification system 10 can be performed. Therefore, even in such a situation, it is possible to allow sale of the specific product requiring age verification at the time of sale. Whether or not acceptance of salesperson 92 on the estimation result of estimation processing unit 16 is required may be switched, for example, by a setting of management apparatus 1. Alternatively, in a case where a probability that the age of customer 91 is equal to or higher than the specific age is obtained by estimation processing unit 16, whether or not acceptance of salesperson 92 on the estimation result of estimation processing unit 16 is required may be automatically switched by the probability. As an example, only in a case where the estimation result of estimation processing unit 16 indicates that a probability that the age of customer 91 is equal to or higher than the specific age is equal to or higher than a predetermined value (for example 90%), acceptance of salesperson 92 is not required, and in other cases, acceptance of salesperson 92 may be required.

In addition, in the embodiment, pre-processing unit 15 is integrally provided with the main body of management apparatus 1 including request processing unit 141 (control unit 14) and the like. On the other hand, the present disclosure is not limited to this configuration, and pre-processing unit 15 may be provided as a unit separated from the main body of management apparatus 1. For example, pre-processing unit 15 may be provided in a housing separated from the main body of management apparatus 1, or may be integrated with imaging device 3. In this case, acquisition unit 12 provided in the main body of management apparatus 1 acquires image data after face detection processing is performed by pre-processing unit 15, that is, image data of a limited image in which a face of customer 91 (target person) appears.

In addition, in the embodiment, estimation processing unit 16 is integrally provided with the main body of management apparatus 1 including request processing unit 141 (control unit 14) and the like. On the other hand, the present disclosure is not limited to this configuration, and estimation processing unit 16 may be provided as a unit separated from the main body of management apparatus 1. For example, estimation processing unit 16 may be provided in a housing separated from the main body of management apparatus 1, or may be integrated with imaging device 3. In this case, acquisition unit 12 provided in the main body of management apparatus 1 acquires the estimation result of estimation processing unit 16 together with the image data.

In addition, in the embodiment, a case where age verification system 10 includes three mobile terminals 2A, 2B, and 2C has been described. On the other hand, age verification system 10 may include at least one mobile terminal 2. For example, age verification system 10 may include one mobile terminal 2, or two or four or more mobile terminals 2. Further, management apparatus 1 is not limited to the configuration in which the request signal is transmitted by multicast. For example, management apparatus 1 may sequentially transmit the request signal to the plurality of mobile terminals 2A, 2B, and 2C by unicast, or may transmit the request signal by broadcast.

In addition, management apparatus 1 may be configured to arbitrarily select mobile terminal 2 to be excluded from transmission destinations of the request signal, among the plurality of mobile terminals 2A, 2B, and 2C. In this case, it is possible to temporarily exclude mobile terminal 2 carried by salesperson 92 who is in a state where age verification cannot be performed, such as salesperson 92 during a break, from transmission destinations of the request signal. Further, by using direct communication between the plurality of mobile terminals 2A, 2B, and 2C, the plurality of mobile terminals 2A, 2B, and 2C may be used for communication between the plurality of salespersons 92A, 92B, and 92C.

In addition, mobile terminal 2 is not limited to a general-purpose device such as a smartphone, and may be a dedicated device for the age verification system. Further, mobile terminal 2 may be a wearable terminal such as a wristwatch-type terminal or an eyeglass-type terminal.

In addition, it is not an essential configuration for age verification system 10 that a notification signal is transmitted to the second mobile terminals when the first mobile terminal transmits a response signal to management apparatus 1. This configuration may be appropriately omitted. Further, it is not an essential configuration for age verification system 10 that display of age verification screen 220 is ended when mobile terminal 2 receives the notification signal. This configuration may be appropriately omitted.

In addition, it is not an essential configuration for age verification system 10 that request processing unit 141 transmits a request signal including text data. Age verification screen 220 may not include a text string. Further, even in a case where age verification screen 220 includes a text string, the text string may not include at least one of information (work instruction) suggesting an action to be performed by the confirmer and information indicating the specific age.

In addition, it is not an essential configuration for shopping assistance system 100 that first communication unit 41, second communication unit 42, and third communication unit 43 are provided in sales system 4. At least one of first communication unit 41, second communication unit 42, and third communication unit 43 may be appropriately omitted. In a case where sales system 4 cannot perform communication with settlement processing system 7, for example, sales system 4 itself may have a function of performing settlement processing of product 90 based on the product information.

In addition, it is not an essential configuration for shopping assistance system 100 that storage unit 45 and interface 46 are provided in sales system 4. At least one of storage unit 45 and interface 46 may be appropriately omitted.

In addition, it is not an essential configuration for shopping assistance system 100 that packing device 61 completes packing processing of transferring product 90 from shopping basket 5 to a container after settlement processing is completed. Packing device 61 may complete packing processing before settlement processing is completed. In this case, there is an advantage that a time required for shopping can be further shortened.

In addition, it is not an essential configuration for shopping assistance system 100 that settlement processing system 7 does not start settlement processing of the specific product unless sales system 4 receives the permission signal. This configuration may be appropriately omitted.

In addition, shopping basket 5 is not limited to the configuration that customer 91 can hold with his or her hand. For example, shopping basket 5 integrated with a cart may be provided.

Further, the communication method between management apparatus 1 and mobile terminal 2 is not limited to wireless communication using radio waves as a medium. For example, optical wireless communication using light as a medium, or communication via a repeater (router) connected to management apparatus 1 by wire, or the like may be used. The communication method between age verification system 10 (management apparatus 1) and sales system 4 is not limited to wired communication. For example, wireless communication using radio waves as a medium, optical wireless communication using light as a medium, or the like may be used. The communication method between sales system 4 and shopping basket 5 is not limited to optical wireless communication using light as a medium. For example, wireless communication such as Wi-Fi (registered trademark) or Bluetooth (registered trademark) using radio waves as a medium, wired communication, or the like may be used. The communication method between sales system 4 and settlement processing system 7 is not limited to wired communication. For example, wireless communication using radio waves as a medium, optical wireless communication using light as a medium, or the like may be used.

In addition, the present disclosure is not limited to the configuration in which the notification signal is transmitted from management apparatus 1 to the second mobile terminals when management apparatus 1 receives the response signal from the first mobile terminal. The notification signal may be directly transmitted from the first mobile terminal to the second mobile terminals. In this case, the first mobile terminal may transmit the notification signal to the second mobile terminals separately from the response signal. Alternatively, for example, by causing the first mobile terminal to transmit the response signal by broadcasting, the second mobile terminals may receive the response signal from the first mobile terminal, as a notification signal. In the latter case, in the second mobile terminals, the response signal from the first mobile terminal is also used as the notification signal. Further, in a case where the notification signal is transmitted from management apparatus 1 to the second mobile terminals, in the second mobile terminals, the acknowledgment (ACK) from management apparatus 1 to the first mobile terminal may be also used as the notification signal.

Further, in the embodiment, a case where mobile terminal 2 performs incoming call notification and immediately displays age verification screen 220 when receiving the request signal, is described. On the other hand, the present disclosure is not limited to the configuration, and mobile terminal 2 may display an introduction screen before displaying age verification screen 220. The introduction screen is a screen for confirming whether or not salesperson 92 who carries mobile terminal 2 can respond, and includes, for example, a text string representing a work instruction to salesperson 92 such as “age verification request”, and OK button and NG button similar to the buttons of age verification screen 220. In this case, only when salesperson 92 operates the OK button on the introduction screen, age verification screen 220 including image 221 is displayed on mobile terminal 2. Further, in this case, when the OK button is operated on the introduction screen of one mobile terminal 2 among the plurality of mobile terminals 2A, 2B, and 2C, in response to the operation, preferably, a notice signal is transmitted to other mobile terminals 2.

In addition, display device 63 is not limited to the configuration in which an image is projected onto an object by a projection mapping technique, and may be, for example, a touch panel display. Further, input device 64 may be provided being separated from display device 63, and, for example, input device 64 including a mechanical switch may be used as at least a part of input means of customer 91 for sales system 4.

Display device 63 is fixed to a lower surface of supply unit 62, and is configured to project an image on a screen by, for example, a projection mapping technique. Here, display device 63 projects an image on a right area of recess 82 on upper surface 81 of counter table 8 when counter table 8 is viewed from the front. That is, the right area of recess 82 on upper surface 81 of counter table 8 is served as screen 631 of display device 63. In the example of FIG. 3, a cigarette menu screen for selecting brands of cigarettes is displayed on screen 631.

In addition, cigarette sales processing may be performed not only after the purchase list is created by sales system 4 as in the embodiment, but also before the purchase list is created.

In addition, it is not an essential configuration for shopping assistance system 100 that management apparatus 1 and sales system 4 are integrated in one housing (counter table 8), and, for example, the components of shopping assistance system 100 may be provided being distributed in a plurality of housings. Further, it is not an essential configuration for shopping assistance system 100 that the components of each of management apparatus 1 and sales system 4 are integrated in one housing, and the components of each of management apparatus 1 and sales system 4 may be provided being distributed in a plurality of housings.

In addition, age verification system 10 may not be used together with sales system 4 configured to allow purchase of product 90 without requiring an operation of salesperson 92 as in the embodiment. For example, age verification system 10 may be used in a situation where salesperson 92 is present at a checkout counter as in a so-called manned checkout. Further, age verification system 10 may be applied not only to sale of product 90 in a store such as a retail store but also to various uses requiring age verification. For example, in a case where age verification is required for a user who orders a liquor by operating a self-order terminal at a restaurant or a user who uses age-limited amusement facility, age verification system 10 according to the embodiment may be applied.

In addition, even in a case where age verification system 10 is used together with sales system 4, it is not an essential configuration for shopping assistance system 100 that sales system 4 stops sales processing of the specific product unless the permission signal is received from management apparatus 1. This configuration may be appropriately omitted.

The above-described various modification examples can be appropriately combined and applied.

(5) Summary

As described above, age verification system (10) according to a first aspect of the present disclosure includes management apparatus (1) and at least one mobile terminal (2, 2X, or 2Y) that can perform bidirectional communication with management apparatus (1). Management apparatus (1) includes request processing unit (141) that transmits a request signal including image data of an image obtained by capturing a target person (customer 91) as a target of age verification to mobile terminal (2, 2X, or 2Y). Mobile terminal (2, 2X, or 2Y) includes display unit (22), operation unit (23), and response processing unit (241). Display unit (22) displays age verification screen (220) including image (221) by using the image data included in the request signal. Operation unit (23) receives an operation by a confirmer (salesperson 92) different from the target person. When a result of age verification performed by the confirmer who views age verification screen (220) is received by operation unit (23), response processing unit (241) transmits a response signal including the result of age verification to management apparatus (1).

According to this configuration, the image data of the image obtained by capturing the target person is transmitted from management apparatus (1) to mobile terminal (2, 2X, or 2Y), and thus the confirmer can confirm the age of the target person by viewing image (221) of the target person on age verification screen (220) displayed on mobile terminal (2, 2X, or 2Y). Further, since the result of the age verification performed on mobile terminal (2, 2X, or 2Y) is returned from mobile terminal (2, 2X, or 2Y) to management apparatus (1) as a transmission source of the request signal, and a series of processing for the age verification is started on management apparatus (1) and is completed on management apparatus (1). Therefore, in a case where the confirmer carries mobile terminal (2, 2X, or 2Y), even when the confirmer is at a place away from the target person, the confirmer can confirm the age of the target person without leaving the place, that is, without moving from the place. In addition, for age verification, the target person does not need to wait for arrival of a confirmer who is at a place away from the target person. As a result, according to age verification system 10, according to age verification system (10), there is an advantage that age verification can be realized while reducing labor of a person.

In age verification system (10) according to a second aspect of the present disclosure, in the first aspect, preferably, imaging device (3) that captures the target person is further included, and management apparatus (1) acquires the image data from imaging device (3).

According to this configuration, age verification system (10) can perform age verification of the target person by using image (221) obtained by capturing the target person in real time by imaging device (3).

In age verification system (10) according to a third aspect of the present disclosure, in the second aspect, preferably, management apparatus (1) further includes pre-processing unit (15). Preferably, pre-processing unit (15) detects a face of the target person by performing image analysis of the image data acquired from imaging device (3), and transmits a request signal including the image data to request processing unit (141).

According to this configuration, age verification system (10) can limit image (221) to be used for age verification of the target person to image (221) in which the face of the target person appears. Therefore, the confirmer can easily perform age verification by viewing image (221).

In age verification system (10) according to a fourth aspect of the present disclosure, in the second aspect or the third aspect, preferably, management apparatus (1) further includes estimation processing unit (16). Estimation processing unit (16) estimates whether an age of the target person is equal to or higher than a specific age by performing image analysis of the image data acquired from imaging device (3). Preferably, request processing unit (141) transmits a request signal including the estimation result of estimation processing unit (16) to mobile terminal (2, 2X, or 2Y).

According to this configuration, the confirmer can perform age verification with reference to the estimation result of estimation processing unit (16), and thus it is possible to reduce a burden of age verification by the confirmer.

In age verification system (10) according to a fifth aspect of the present disclosure, in any one of the first to fourth aspects, preferably, a plurality of mobile terminals (2, 2X, or 2Y) are provided, and request processing unit (141) simultaneously transmits a request signal to the plurality of mobile terminals (2, 2X, or 2Y).

According to this configuration, in a case where there are a plurality of confirmers as in a store in which a plurality of salespersons (92) are present, management apparatus (1) can simultaneously request the plurality of confirmers to perform age verification.

In age verification system (10) according to a sixth aspect of the present disclosure, in the fifth aspect, preferably, when a first mobile terminal transmits a response signal to management apparatus (1), a notification signal is transmitted to second mobile terminals. The first mobile terminal is one mobile terminal among the plurality of mobile terminals (2, 2X, or 2Y). The second mobile terminals are mobile terminals different from the first mobile terminal among the plurality of mobile terminals (2, 2X, or 2Y).

According to this configuration, in a case where age verification is performed by any one of the plurality of mobile terminals (2, 2X, or 2Y), it is possible to notify the other mobile terminals (2, 2X, or 2Y) of a fact that the age verification is ended.

In age verification system (10) according to a seventh aspect of the present disclosure, in the sixth aspect, each of the plurality of mobile terminals (2, 2X, or 2Y) is configured to end display of age verification screen (220) on display unit (22) when receiving the notification signal.

According to this configuration, in a case where age verification is performed by any one of the plurality of mobile terminals (2, 2X, or 2Y), it is possible to automatically end display of age verification screen (220) on display unit (22) of the other mobile terminals (2, 2X, or 2Y).

In age verification system (10) according to an eighth aspect of the present disclosure, in any one of the first to seventh aspects, preferably, request processing unit (141) is configured to transmit a request signal including text data. Preferably, display unit (22) is configured to display age verification screen (220) including a text string based on the text data.

According to this configuration, the text string is also displayed together with image (221) on age verification screen (220), and thus the confirmer can recognize various information from age verification screen (220).

In age verification system (10) according to a ninth aspect of the present disclosure, in the eighth aspect, preferably, the text string includes information for suggesting an action to be performed by the confirmer.

According to this configuration, the confirmer can recognize an action to be performed by viewing age verification screen (220), and thus age verification system (10) can be used to transfer a work instruction or the like.

In age verification system (10) according to a tenth aspect of the present disclosure, in the eighth or ninth aspect, preferably, the text string includes information indicating a specific age as a reference for comparison with an age of the target person in the age verification.

According to this configuration, the confirmer can recognize the specific age as a reference for comparison with an age of the target person in the age verification by viewing age verification screen (220). Therefore, for example, even in a case where the specific age differs depending on the specific product, the confirmer can perform age verification according to the specific product by viewing age verification screen (220) displayed on mobile terminal (2, 2X, or 2Y).

In age verification system (10) according to an eleventh aspect of the present disclosure, in any one of the first to tenth aspects, preferably, mobile terminal (2X or 2Y) further includes attachment portion (20) for directly or indirectly attaching mobile terminal (2X or 2Y) to the confirmer. Preferably, display unit (22) is configured to display name tag screen (230) including identification information for identifying the confirmer.

According to this configuration, mobile terminal (2X or 2Y) can function as a name tag which displays identification information for identifying the confirmer.

In age verification system (10) according to a twelfth aspect of the present disclosure, in the eleventh aspect, preferably, display unit (22) is a memory-type display that maintains display of a screen displayed by energizing display unit (22) until at least a predetermined time elapses from a stop timing of the energization.

According to this configuration, mobile terminal (2X or 2Y) can stop energization to display unit (22) except for a time of updating the displayed screen, and thus, it is possible to suppress power consumption in display unit (22).

In age verification system (10) according to a thirteenth aspect of the present disclosure, in the twelfth aspect, preferably, mobile terminal (2X or 2Y) is configured to operate by power supply from battery (28). Preferably, display unit (22) is configured to display name tag screen (230) in a case where at least a remaining capacity of battery (28) is equal to or less than a threshold value.

According to this configuration, display unit (22) can maintain display of name tag screen (230) even after the remaining capacity of battery (28) is lowered and mobile terminal (2X or 2Y) is turned off, and thus mobile terminal (2X or 2Y) can maintain the function as a name tag.

In age verification system (10) according to a fourteenth aspect of the present disclosure, in any one of the eleventh to thirteenth aspects, preferably, mobile terminal (2X or 2Y) further includes display control unit (242) that controls display unit (22). Preferably, display control unit (242) is configured to switch between a first mode and a second mode according to a direction of display unit (22), the first mode in which name tag screen (230) is displayed on display unit (22), and the second mode in which a screen other than name tag screen (230) is displayed on display unit (22).

According to this configuration, the screen displayed on display unit (22) is automatically switched according to the direction of display unit (22), and thus it is possible to omit an operation or the like for switching the screen.

Shopping assistance system (100) according to a fifteenth aspect of the present disclosure includes: age verification system (10) of any one of the first to fourteenth aspects; and sales system (4) that can perform communication with management apparatus (1) and performs sales processing of product (90). In a case where a specific product is sold in sales system (4), management apparatus (1) is configured to transmit the request signal to mobile terminal (2, 2X, or 2Y), and transmit a permission signal to sales system (4) when receiving the response signal indicating pass of the age verification from mobile terminal (2, 2X, or 2Y). The specific product is a product requiring age verification of the target person at the time of sale.

According to this configuration, in response to a fact that the specific product is sold on sales system (4), management apparatus (1) transmits a request signal to mobile terminal (2, 2X, or 2Y), and age verification system (10) starts a series of processing for age verification. In addition, when a result of the age verification is pass, a permission signal is transmitted from management apparatus (1) to sales system (4), and thus sales system (4) can receive the result of the age verification performed on age verification system (10). For example, in a case where customer (91) intends to purchase a specific product such as a cigarette or a liquor using sales system (4), age verification is performed on age verification system (10), and a result of the age verification is transmitted to sales system (4). Therefore, according to shopping assistance system (100), there is an advantage that age verification can be realized while reducing labor of a person.

In shopping assistance system (100) according to a sixteenth aspect of the present disclosure, in the fifteenth aspect, preferably, sales system (4) is configured to stop sales processing of the specific product when the permission signal is not received from management apparatus (1). Preferably, sales system (4) is configured to continue sales processing of the specific product when the permission signal is received from management apparatus (1).

According to this configuration, in a case where age verification on age verification system (10) is failed, it is possible to automatically stop sales processing of the specific product by sales system (4).

As described above, according to the age verification system of the present disclosure and the shopping assistance system including the age verification system, there is an advantage that age verification can be realized while reducing labor of a person.

### REFERENCE MARKS IN THE DRAWINGS

1 MANAGING APPARATUS

2, 2A, 2B, 2C, 2X, 2Y MOBILE TERMINAL

3 IMAGING DEVICE

4 SALES SYSTEM

10 AGE VERIFICATION SYSTEM

15 PRE-PROCESSING UNIT

16 ESTIMATION PROCESSING UNIT

20 ATTACHMENT PORTION

22 DISPLAY UNIT

23 OPERATION UNIT

28 BATTERY

91 CUSTOMER (TARGET PERSON)

92, 92A, 92B, 92C SALESPERSON (CONFIRMER)

100 SHOPPING ASSISTANCE SYSTEM

141 REQUEST PROCESSING UNIT

220 AGE VERIFICATION SCREEN

221 IMAGE

230 NAME TAG SCREEN

241 RESPONSE PROCESSING UNIT

242 DISPLAY CONTROL UNIT

1. An age verification system comprising:
a management apparatus including
a request processing unit transmitting a request signal including image data of an image obtained by capturing a target person; and
a mobile terminal including
a communication unit that receives the request signal from the management apparatus,
a display unit that displays an age verification screen including the image by using the image data included in the request signal,
an operation unit that receives an operation input by a confirmer when the age verification screen is viewed by the confirmer, as an age verification result, and
a response processing unit that transmits a response signal including the age verification result received by the operation unit to the management apparatus.

2. The age verification system of claim 1, further comprising:
an imaging device that creates the image data by capturing the target person,
wherein the management apparatus is configured to acquire the image data from the imaging device.

3. The age verification system of claim 2,
wherein the management apparatus further includes a pre-processing unit, and
wherein the pre-processing unit detects a face of the target person by performing image analysis of the image data acquired from the imaging device, and causes the request processing unit to transmit the request signal including the image data.

4. The age verification system of claim 2,
wherein the management apparatus further includes an estimation processing unit,
wherein the estimation processing unit estimates whether or not an age of the target person is equal to or higher than a specific age by performing image analysis of the image data acquired from the imaging device, and
wherein the request processing unit is configured to transmit the request signal including an estimation result of the estimation processing unit to the mobile terminal.

5. The age verification system of claim 1,
wherein the mobile terminal is one of a plurality of the mobile terminals, and
wherein the request processing unit is configured to simultaneously transmit the request signal to the plurality of mobile terminals.

6. The age verification system of claim 5,
wherein, when one first mobile terminal among the plurality of mobile terminals transmits the response signal to the management apparatus, a notification signal is transmitted from the management apparatus to second mobile terminal different from the first mobile terminal among the plurality of mobile terminals.

7. The age verification system of claim 6,
wherein each of the plurality of mobile terminals is configured to end display of the age verification screen on the display unit when receiving the notification signal.

8. The age verification system of claim 1,
wherein the request processing unit is configured to transmit the request signal including text data, and
wherein the display unit is configured to display the age verification screen including a text string using the text data.

9. The age verification system of claim 8,
wherein the text string includes information for suggesting an action to be performed by the confirmer.

10. The age verification system of claim 8,
wherein the text string includes information indicating a specific age as a reference for comparison with an age of the target person in the age verification.

11. The age verification system of claim 1,
wherein the mobile terminal further includes an attachment portion for directly or indirectly attaching the mobile terminal to the confirmer, and
wherein the display unit is configured to be able to display a name tag screen including identification information for identifying the confirmer.

12. The age verification system of claim 11,
wherein the display unit is a memory-type display that maintains display of a screen displayed by energizing the display unit until at least a predetermined time elapses from a stop timing of the energization.

13. The age verification system of claim 12,
wherein the mobile terminal is configured to operate by power supply from a battery, and
wherein the display unit is configured to display the name tag screen in a case where a remaining capacity of the battery is equal to or less than a threshold value.

14. The age verification system of claim 11,
wherein the mobile terminal further includes a display control unit that controls the display unit, and
wherein the display control unit is configured to switch between a first mode and a second mode according to a direction of the display unit, the first mode allowing the name tag screen to be displayed on the display unit, and the second mode allowing a screen other than the name tag screen to be displayed on the display unit.

15. A shopping assistance system comprising:
the age verification system of claim 1; and
a sales system that is able to perform communication with the management apparatus and perform sales processing of a product,
wherein, in a case where a specific product requiring age verification of the target person at the time of sale is sold in the sales system,
the management apparatus is configured to
transmit the request signal to the mobile terminal, and
transmit a permission signal to the sales system when receiving the response signal indicating pass of the age verification from the mobile terminal.

16. The shopping assistance system of claim 15,
wherein the sales system is configured to
continue the sales processing of the specific product when the permission signal is received from the management apparatus, and
stop the sales processing of the specific product when the permission signal is not received from the management apparatus.
